(19) United States
(12) Patent Application Publication
(10) Pub. No.: US 2020/0129379 A1
(43) Pub. Date: Apr. 30, 2020

(54) Medicine Dispensing Device

(71) Applicant: Yuyama Mfg. Co., Ltd., Osaka (JP)

(72) Inventor: Masao FUKADA, Osaka (JP)

(73) Assignee: Yuyama Mfg. Co., Ltd., Osaka (JP)

(21) Appl. No.: 16/627,286

(22) PCT Filed: Jun. 26, 2018
(86) PCT No.: PCT/JP2018/024075

§ 371 Date: Dec. 28, 2019

(30) Foreign Application Priority Data
Jun. 29, 2017 (JP) 2017-127991

(51) Int. Cl. A61J 7/00; A61J 7/02; B65D 83/00; B65D 83/04

(52) U.S. Cl. CPC A61J 7/0084; A61J 7/02; A61J 2200/70; B65D 83/0481; B65D 83/0083

(57) ABSTRACT

[Technical Problem]

To improve convenience of a medicine dispensing apparatus.

[Solution to Problem]

A medicine dispensing apparatus (1) includes a first rotator, a second rotator, a counter (26), a recovering path (22) having a recovering end (22A), a dispensing end (21) having a dispensing end (21A) disposed in a position higher than the recovering end, and a switching mechanism (25) for switching a medicine passage path between the dispensing path and the recovering path.

### FIELD OF INVENTION

The disclosure hereinbelow relates to a medicine dispensing apparatus for dispensing medicines.

### BACKGROUND

One example of a medicine supply apparatus capable of supplying medicines having different shapes and sizes (for example, tablets or capsule) outside one by one disclosed in Patent Literature 1. The medicine supply apparatus of Patent Literature 1 comprises a first rotator, a second rotator, a height regulator and a medicine dispenser member. In the medicine supply apparatus, the medicines charged move to the second rotator from the first rotator by rotation of the first rotator and the moved medicines are regulated their movements at a part where the height regulator is disposed.

### PRIOR ART LITERATURE

### Patent Literature

Patent Literature 1: Japanese Patent No. 5146624 (registered on Dec. 7, 2012)

### SUMMARY OF INVENTION

### Problem to be Solved by Invention

Inventors of the present application have performed studies for improving usability of a medicine supply apparatus and have succeeded in developing the technology disclosed hereunder.

An object of one embodiment of the present invention is to realize a medicine dispensing apparatus capable of improving usability.

### Means for Solving Problem

In order to solve the above problem, a medicine dispensing apparatus of one embodiment of the present invention is a medicine dispensing apparatus for sending a plurality of medicines charged in turn, dispensing with counting at least one part of the medicines sent-in-turn, and recovering residues comprises a progressive sending mechanism for sending-in-turn medicines, a counter for counting the medicines sent from the sending-in-turn mechanism, a recovering path having a recovering end for discharging the medicines to be recovered by making them fall, a dispensing path having a dispensing end disposed at a position higher than the recovering end, and a switching mechanism for switching passage paths of the medicines between the dispensing path and the recovering path.

### Technical Advantage of Invention

According to one embodiment of the present invention, the advantage can be attained that usability of a medicine dispensing apparatus is improved.

### BRIEF DESCRIPTION OF DRAWINGS

FIG. 1 A drawing illustrating one example of a schematic configuration of a medicine dispensing system; (a) is a drawing illustrating the condition where a medicine container and a recovery container are set to a medicine dispensing apparatus and (b) is a drawing illustrating the condition where the medicine container and the recovery container are not set.

FIG. 2 A perspective view for illustrating a schematic configuration of the medicine dispensing apparatus, a display device and a certification device.

FIG. 3 A drawing illustrating one example of an inner configuration of the medicine dispensing apparatus; (a) is a perspective view and (b) is a schematic side view for explaining an arrangement relation of a first rotator and a second rotator.

FIG. 4 A front view of one example of the inner configuration of the medicine dispensing apparatus; (a) is a drawing illustrating the condition where a front cover is attached and (b) is a drawing illustrating the condition where the front cover is removed.

FIG. 5 A drawing for explaining cleaning of a fall-down path determination member; (a) is a drawing illustrating the condition where the falling-down path unit is attached, (b) is a drawing illustrating the condition where the falling-down path definition member is removed, and (c) is a rear view of a rear cover.

FIG. 6 A perspective view illustrating one example of an inner configuration of the medicine dispensing apparatus for explaining a counter.

FIG. 7 A perspective view illustrating one example of an inner configuration of the medicine dispensing apparatus; (a) is a drawing illustrating the condition where a height regulating member is positioned at an initial position and (b) is a drawing illustrating the condition where the height regulating member is located at a position after an adjustment.

FIG. 8 A plane view illustrating one example of an inner configuration of the medicine dispensing apparatus; (a) is a drawing illustrating the condition where a width regulating member is positioned at an initial position and (b) is a drawing illustrating the condition where the width regulating member is located at a position after an adjustment.

FIG. 9 A drawing explaining about timing for lowering a sending-in-turn speed under a high-precision dispensing mode; (a) is a drawing when a medicine detection sensor is used and (c) is a drawing when a counter 260 is used.

FIG. 10 A block diagram illustrating one example of each configuration of the medicine dispensing system.

FIG. 11 A flowchart illustrating one example of an entire processing flow in the medicine dispensing system.

FIG. 12 A flowchart illustrating one example of a dispensing processing flow of medicines in the high-precision dispensing mode.

FIG. 13 A flowchart illustrating one example of a processing flow in the high-precision dispensing mode from dispensing processing of the medicine to ending processing of the medicine dispensing apparatus.

FIG. 14 A flowchart illustrating one example of a processing flow under disorder; (a) illustrates the processing when medicine number counted is less than numeral amounts to be dispensed and (b) illustrates the processing when the medicine number counted exceeds the numeral amounts to be dispensed.

FIG. 15(a)-(f) are drawings illustrating each of one example of various display images displayed on a display part.

FIG. 16(a)-(d) are drawings illustrating each of one example of various display images displayed on a display part.

FIG. 17 A drawing illustrating a configuration of the medicine dispensing apparatus for explaining a stage and a recovery container detection sensor.

FIG. 18 A plane view illustrating one example of an inner configuration of the medicine dispensing apparatus.

### MODE FOR PRACTICING INVENTION

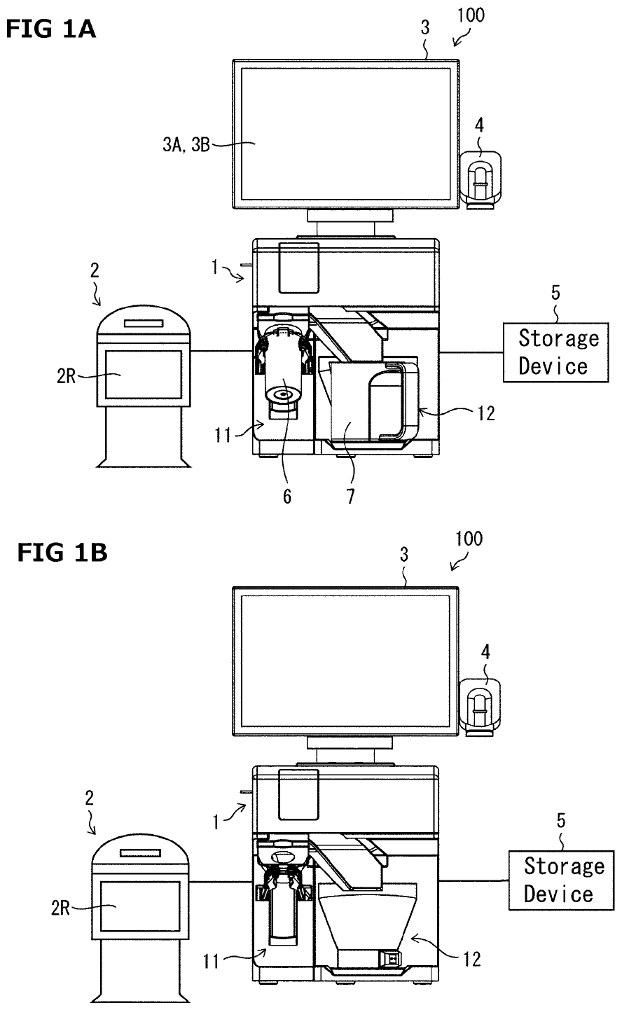

With respect to one embodiment of the present invention, details will be described using FIG. 1-FIG. 16. Medicines to be an object for dispensation of a medicine dispensing apparatus in the present embodiment are not ampules or vials (in other words, medicines enclosed in medicine containers) and directs to medicines which are not received in medicine containers, or medicines in-itself are not applied yet with wrappings and the like. As for one example, in the present embodiment, the explanation will be provided with assuming that the above medicines are tablets or capsules.

Besides, the term “fall” in the present description may include “free fall” inside a dispensing path or a recovering path and “sliding down” on the dispensing path or the recovering path.

Furthermore, according to an embodiment of the present invention, the case, which the medicines are dispensed based on prescription data, is exemplarily described as an example. That is to say, number of amounts to a medicine container is the formulated number included in the prescription data. Not limited thereto, the configuration that medicines having amounts set by a user are dispensed may be possible.

[Configuration of Medicine Dispensing System]

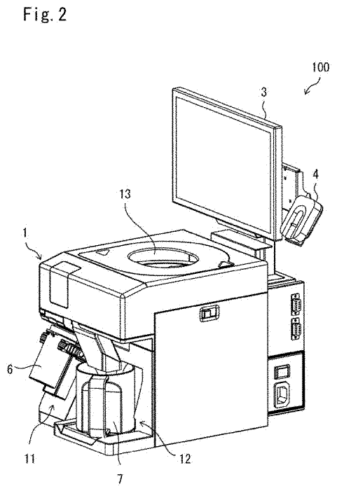

First, a configuration of a medicine dispensing system 100 will be described with using FIG. 1 and FIG. 2. FIG. 1 is a drawing illustrating one example of a schematic configuration of the medicine dispensing system 100; (a) is a drawing in the state where a medicine container 1 and a recovery container 7 are set to the medicine dispensing apparatus 1 and (b) is a drawing in the state where a medicine container 1 and a recovery container 7 are not set to the medicine dispensing apparatus 1. FIG. 2 shows a perspective view illustrating configurations of a medicine dispensing apparatus 1, a display device 3, and a certification device 4.

As shown in Figs. (a) and (b), the medicine dispensing system 100 comprises the medicine dispensing apparatus 1, a reader device 2, the display device 3, the certification device 4 and a storage device 5. Now, each device is illustrated such that each device is connected by wired connections, however, the configuration that is capable of connected by wireless connections may be allowed.

The medicine dispensing apparatus 1 sends-in-turn a plurality of medicines charged, dispenses at least one part of the medicines sent-in-turn with counting, and recovers the remaining medicines. As shown in FIG. 1 (a), the medicine dispensing apparatus 1 includes a first region 11 capable of setting a medicine container 6, a second region 12 capable of setting a recovery container 7 and a medicine charging part 13 into which the medicines are charged as shown in FIG. 2. The medicine charging part 13 is an aperture part (charging aperture) formed at an upper face of a casing of the medicine dispensing apparatus 1. The medicine dispensing apparatus 1 dispenses counted medicines among the medicines charged into the medicine charging part 13 to the medicine container 6 set at the first region 11 and sends out the remaining medicines to the recovery container 7 set at the second region 12. Details of the medicine dispensing apparatus 1 will be described later.

The medicine container 6 is the container which can receive the counted medicine by the medicine dispensing apparatus 1 and may be, for example, a vial. The recovery container 7 is the container which can receive the medicines not dispensed to the medicine container 6 among the charged medicines into the medicine dispensing apparatus 1. As the medicine container 6, there may be various containers having different sizes (height). For example, the size may differ depending on the kinds or the number of the medicines to be formulated. The recovery container 7 may merely be prepared as a container of one kind for the medicine dispensing apparatus 1. That is, in the first region, medicines with various sizes may be set in the first region 11, however, in the second region 12, the recovery container 7 of one kind (the recovery container 7 having a constant size) is set.

The reader device 2 is one that obtains a prescription data indicating medicines (medical prescription) prepared by a medical worker (for example, medical doctor) and a storage medicine data that indicates the medicine in a storage container (original bottle) for storing the medicine. The reader device 2 includes a data reader part 2R for obtaining the prescription data and the storage medicine data. For example, the prescription data and the storage medicine data are each realized by using barcodes. The reader device 2 transmits the read prescription data and the storage medicine data to the medicine dispensing apparatus 1.

The display device 3 includes a display part 3A for displaying various data and an operation part 3B for receiving user operations. The display part 3A is realized, for example, by a liquid crystal display panel and the operation part 3B is realized, for example, by a touch panel overlay on the display part 3A.

The certification device 4 obtains user data that indicate identification information of the user for the medicine dispensing apparatus 1, performs the certification whether or not the user is registered, and transmits certification results to the medicine dispensing apparatus 1. The certification device 4 is realized, for example, by a finger-print certification device.

The storage device 5 is one that stores various data to be required in the medicine dispensing system 100. As stored data may be, for example, registered medicine data (master) including registered user data indicating the identification information of the user registered as the user of the medicine dispensing apparatus 1, or medicine names of medicines of each kind (example: medicine ID (Identification)) end the like. Furthermore, it may be included that the registered precipitation data that is the precipitation data registered when the precipitation has been made. For each of the registered precipitation data, the medicine names (medicine kind IDs) designated by the precipitation are associated with and are stored in the storage device 5.

The registered user data may be used, for example, to check the user data in the certification device 4. Furthermore, the registered precipitation data may be used, for example, to check the precipitation data or the stored medicine data in the medicine dispensing apparatus 1.

[Configuration of Medicine Dispensing Apparatus]

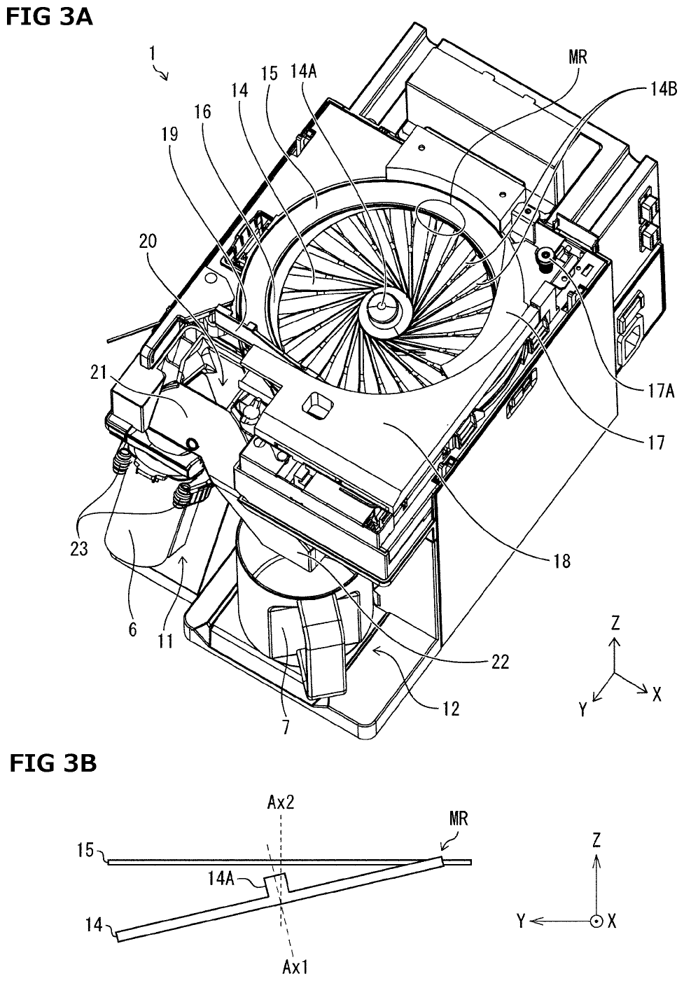

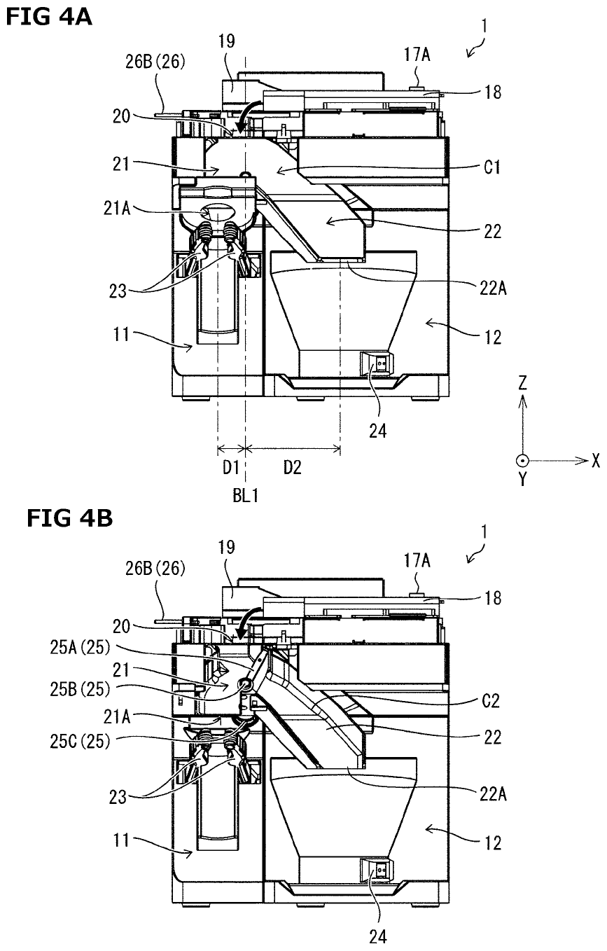

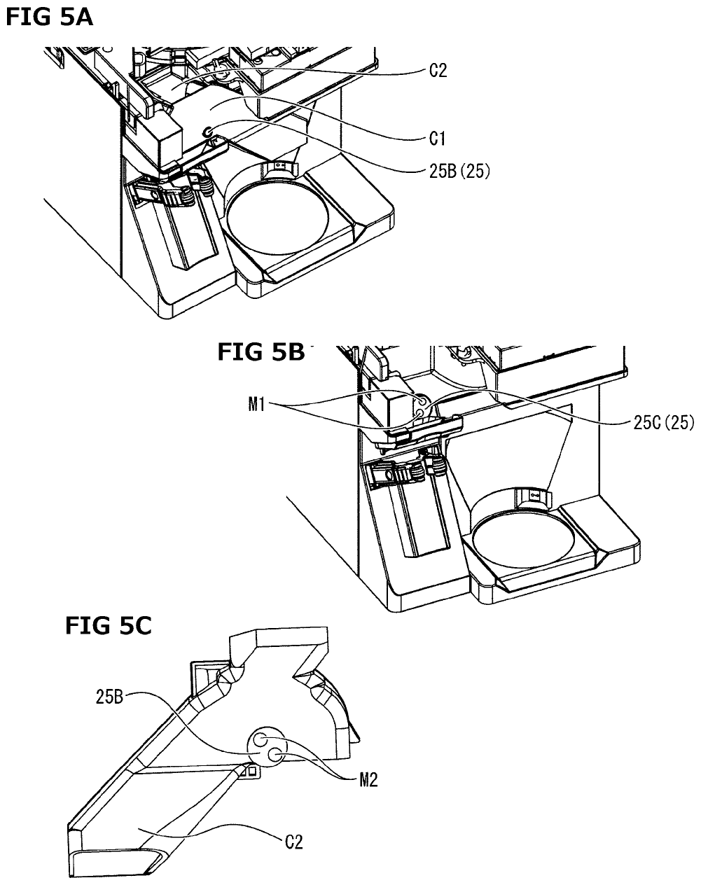

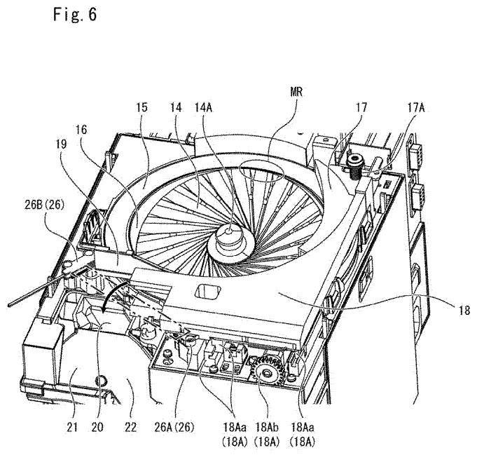

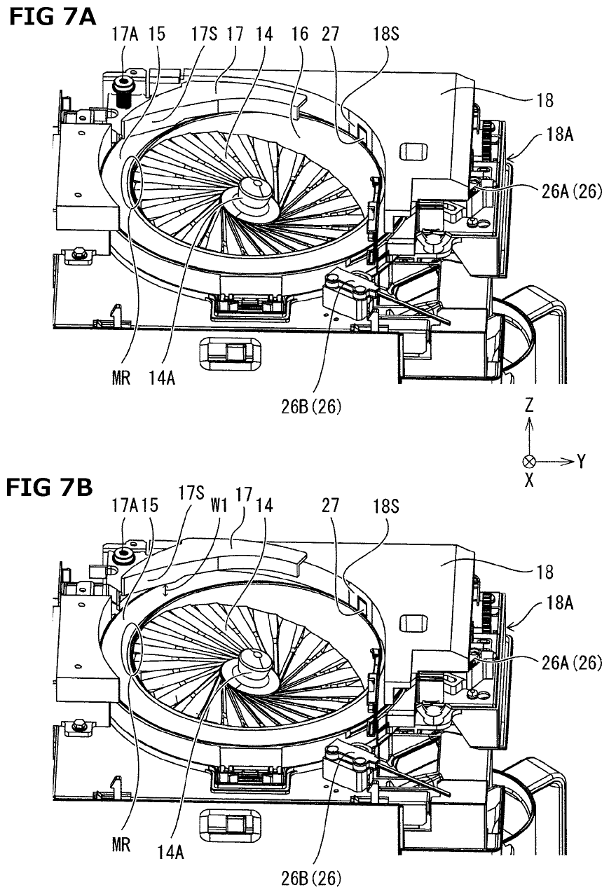

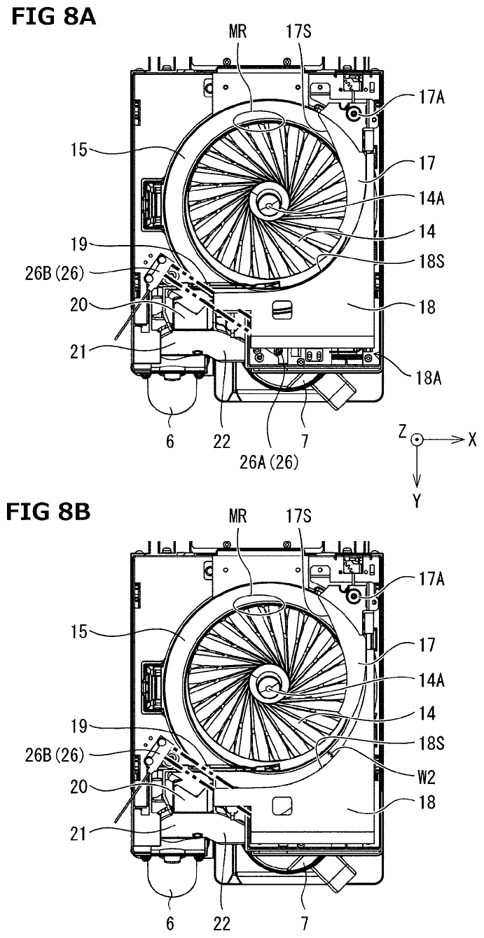

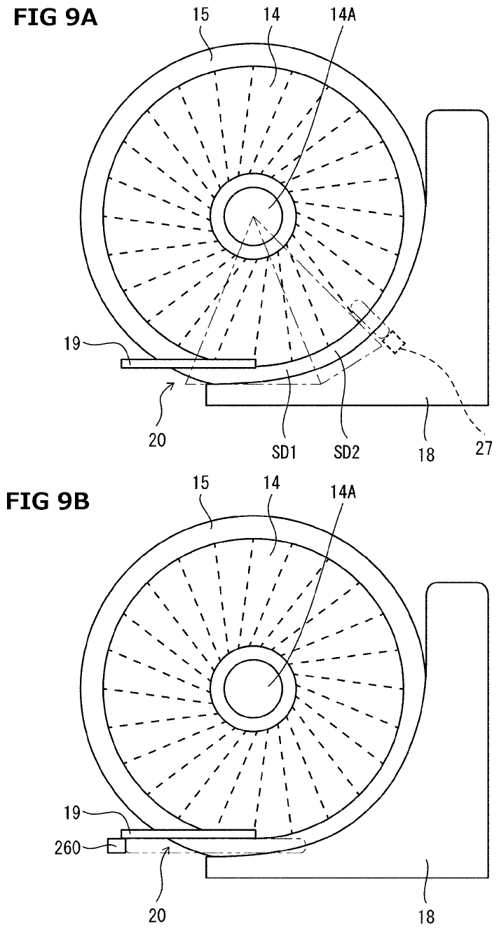

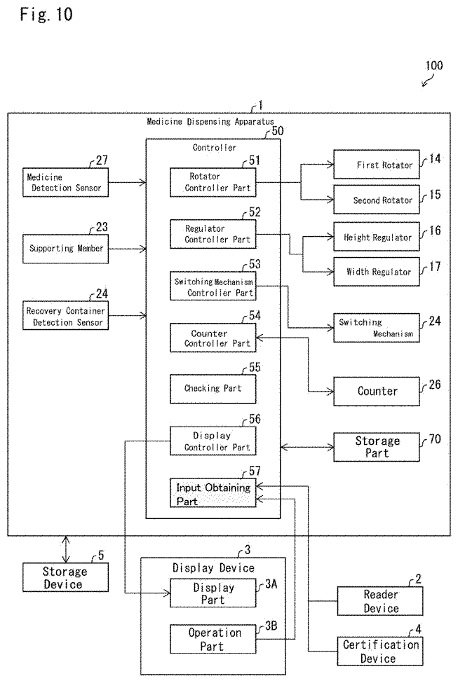

Next, using FIG. 3-FIG. 10, a configuration of the medicine dispensing apparatus 1 will be explained. FIG. 3 is a drawing illustrating one example of the inner configuration of the medicine dispensing apparatus 1; (a) is a perspective view, and (b) is a schematic side view for explaining orientation relationships of the first rotator 14 and the second rotator 15. FIG. 4 is a front view of one example of an inside configuration of the medicine dispensing apparatus 1; (a) is a drawing illustrating the condition where a front cover C1 is attached and (b) is a drawing illustrating the condition where the front cover C1 is removed. FIG. 5 is a drawing for explaining cleaning of a fall-down path determination member; (a) is a drawing illustrating the condition where the fall-down path determination member is equipped, (b) is a drawing illustrating the condition where the fall-down path determination member is removed and (c) is a rear view of a rear cover C2. FIG. 6 is a perspective view illustrating one example of the inner configuration of the medicine dispensing apparatus 1 and is a drawing for explaining a counter 26. FIG. 7 is a perspective view illustrating one example of the inner configuration of the medicine dispensing apparatus 1; (a) is a drawing illustrating the condition where a height regulator 17 is positioned at an initial position and (b) is a drawing illustrating the condition where the height regulator 17 is positioned at a position after adjustment. FIG. 8 is a plane view illustrating one example of the inner configuration of the medicine dispensing apparatus 1; (a) is a drawing illustrating the condition where a width regulator 18 is positioned at an initial position and (b) is a drawing illustrating the condition where the width regulator 18 is positioned at the position after adjustment. FIG. 9 is a drawing for explaining timing for decreasing a send-in-turn speed of the medicine under a high-precision dispensing mode; (a) is a drawing illustrating the case using a medicine detection sensor 27 and (b) is a drawing illustrating the case using a counter 260. FIG. 10 is a block diagram illustrating one example of each configuration of the medicine dispensing system 100.

As shown In FIG. 3 (a), the medicine dispensing apparatus 1 comprises a first region 11, a second region 12, a first rotator 14, a second rotator 15, a partition wall 16, a height regulator 17, a width regulator 18, a width regulation wall 19, a medicine falling-down part 20, a dispensing path 21, a recovery path 22 and a supporting member 23.

With respect to the medicine dispensing apparatus 1, the medicine charged into the medicine charging part 13 (refer to FIG. 2) is placed on the first rotator 14. Thereafter, the medicine moves to the second rotator 15 from the first rotator 14 by rotation of the first rotator 14 at a moving region MR and then falls down to the medicine falling-down part 20 on and from the second rotator 15. The medicine fallen-down to the medicine falling-down part 20 is moved to the dispensing path 21 or the recovering path 22. The medicines on the second rotator 15 are aligned by the height regulator 17, the width regulator 18 and the width regulation wall 19. The medicines passed through the dispensing path 21 are dispensed to the medicine container 6 supported with the supporting member 23 at the first region 23 while the medicines passed through the recovering path 22 are received in the recovery container 7 placed at the second region 12. Hereinbelow, each of the members will be explained in detail.

<First Rotator-Second Rotator>

The first rotator 14 and the second rotator 15 function send-in-turn mechanism for making the charged medicines send in turn. When sending in turn, the charged medicines are moved to ward the medicine falling-down part 20. Here, the height regulator 17 and the width regulator 18 also function as a part of the send-in-turn mechanism.

The first rotator 14 is, by the rotation, a rotation member for making the charged medicines move toward an outer peripheral side (radially and outwardly). Particularly, as shown in FIG. 3 (a), the first rotator 14 is a disk-shaped rotation member which rotates about a first axis part 14A.

As shown in FIG. 3 (b), the first rotator 14 is disposed slantedly to an XY plane (example: a mounting plane of the medicine dispensing apparatus 1) (also refer to FIG. 7).

As shown in FIG. 3 (a), convex ridges 14B are disposed radially on an upper face of the first rotator 14. The medicine 14 charged to the first rotator 14 move toward the outer peripheral part due to centrifugal force generated by the rotation of the first rotator 14.

The partition wall 16 stands along the outer peripheral part of the first rotator 14. Thereby, the charged medicine can be placed on the first rotator 14. Particularly, the charged medicines are received in a retainer space defined by the first rotator 14 and the partition wall 16.

The medicine dispensing apparatus 1 includes in its inside a first rotation controller mechanism for controlling the rotation of the first rotator 14. Actuation of the first rotation controller mechanism (in other words, rotation control of the first rotator 14) is controlled by a rotator controller part 51 (refer to FIG. 10).

The second rotator 15 is a cylindrical rotation member and is positioned at upper side of the first rotator 14 (+Z axis direction). The second rotator 15 is, as shown in FIG. 3(b), placed horizontally such that a second rotation axis Ax2 of the second rotator 15 extends to the ±Z axis direction and its upper face becomes approximately parallel to the XY plane. That is, the second rotation axis Ax2 of the second rotator 15 extends to the different direction with respect to a first rotation axis Ax1 of the first rotator 14.

Besides, the second rotator 15 is, when viewed from an axis direction of the second rotation axis Ax2 (+Z axis direction), disposed along the outer periphery of the first rotator 14. Furthermore, as shown in FIG. 3(b) and FIG. 6, by the slant of the first rotator 14, the outer peripheral part of the first rotator is lowered with respect to an inner peripheral part of the second rotator 15 and a step with a certain height is formed therebetween (the difference of elevation in the ±Z axis direction between the first rotator 14 and the second rotator 15). The part where the step becomes minimum functions as a moving region MR where the charged medicines move to the second rotator 15 from the first rotator 14.

Furthermore, the second rotator 15 sends in turn the medicines coming from the first rotator 14 to the medicine falling-down part 20.

At least a part of the medicines moved to the second rotator 15 from the first rotator 14 at the moving region MR are moved to the medicine falling-down part 20 while remaining medicines are made to fall to a side of the first rotator 14 by the height regulator 17 and the width regulator 18. As described above, the first rotator 14 and the second rotator 15 form a medicine moving region for moving the charged medicines to the medicine falling-down part 20. The medicine moving region is described as a region spreading to the different direction with respect to the fall-down direction of the medicine from the medicine falling-down part 20 (direction including the −Z axis direction). In other words, the medicine moving region may be defined as the region spreading to the horizontal direction along the upper face of the second rotator 15.

The medicine falling-down part 20 is an aperture part where the medicines fallen down from the second rotator 15 are sent to the dispensing path 21 or the recovering path 22. The medicine falling-down part 20 is formed by the front cover C1 (refer to FIG. 4 (a)) and the rear cover C2 (refer to FIG. 4 (b)) for defining the dispensing path 21 and the recovering path 22.

Now, the medicine dispensing apparatus 1 includes an outer frame (not shown) standing along the outer peripheral part of the second rotator 15. Thereby, the medicines above the second rotator 15 can be moved to the medicine falling-down part 20 or can be made to fall only to the side of the first rotator 14.

The medicine dispensing apparatus includes in its inside a second rotation controller mechanism for controlling the rotation of the second rotator 15 (hot shown). Actuation of the second rotation controller mechanism (in other words, rotation control of the second rotator 15) is also controlled by the rotator controller part 51.

(Switching between High-Speed Dispensing Mode and High-Precision Dispensing Mode)

The second rotator 15 can be switched between a high-speed dispensing mode (first mode) and a high-precision dispensing mode (second mode). In other words, the rotation controller part 51, by switching the above two modes, controls the rotation speeds of the second rotator 15 (send-in-turn speed of the medicines).

Here, the first rotator 14 is not necessarily always rotated during dispensing processing and, for example, may rotate only when there is no medicine above the second rotator 15. Now, presence of the medicines above the second rotator 15 may be performed by the medicine detection sensor 27 (described later).

The high-speed dispensing mode is the mode that sends in turn at a constant speed (certain speed) until the medicines of dispensing amounts set beforehand is counted. The high-precision dispensing mode is the mode that sends in turn by lowering the rotation speed when the medicines of certain amounts less than the amounts to be dispensed are counted.

For example, it is assumed that the amounts to be dispensed are 40 tablets.

Under the high-speed dispensing mode, the rotator controller part 51 makes the second rotator 15 rotate at a predetermined speed until the counter 26 (described later) counts up to 40 tablets. When the count reaches 40 tablets, the rotator controller part 51 makes the second rotator 15 stop. In this case, though there is the possibility that some medicines are dispensed to the medicine container 6 after stopping, the numeral amounts of the medicines near to the numeral amounts to be dispensed may be dispensed to the medicine container 6 promptly. It is thought that the medicine dispensed to much is several pieces, the user confirms the number counted by the counter 26 (example: 43 pieces) and only removes the several pieces (3 pieces) from the medicine container 6.

On the other hand, under the high-precision dispensing mode, the rotator controller part 51 decreases its rotation speed when the counter 26 counts up to predetermined numeral amounts less than the numeral amounts to be dispensed. For example, after the rotator controller part 51 counts up the medicine by the predetermined numeral amounts less than the numeral amounts to be dispensed and when the medicine detection sensor 27 detects the medicine, the rotator controller part 51 decreases the rotation speed from a predetermined speed (first speed) to a speed lower than the first speed (second speed). Particularly, the rotator controller part 51 decreases to the second speed when the medicine detection sensor 27 detects the medicine after the above counting and the medicine present at the slow-down region (SD range) SD1 or SD2 indicated by the frame of one dot chain line in FIG. 9 (a). Thereafter, the rotator controller part 51, after passing a predetermined time duration (particularly, in the case that no medicine is present at the SD range SD1 and SD2), may return the rotation speed to the first speed from the second speed.

Here, the first speed may be set at any speed so far as the counter 26 can count the medicines fallen down from the second rotator 15. The second speed may be set at any speed so far as the numeral amounts dispensed from the second rotator 15 can be controlled one by one with respect to one tablet. Furthermore, the predetermined numeral amounts less than the numeral amounts to be dispensed means the numeral amounts to be set such that no dispensation from the second rotator 15 over the numeral amounts to be dispensed (40 tablets) can not occur by switching the rotation speed from the second speed to stop when the predetermined numeral amounts are counted. The predetermined numeral amounts may be set, for example, between 30 pieces and 35 pieces.

When the 40th tablet has counted, since sequential falling-down of the 41th tablet is avoided, the 40 tablets can be dispensed precisely to the medicine container 6.

In this case, the work for removing the medicine over-dispensed as described above from the medicine container 6 is not omitted. However, there is the possibility that the high-speed dispensing mode rather than the high-precision dispensing mode can make the time required for dispensation processing of the medicine short in the medicine dispensing apparatus 1.

Besides, the second rotator 15, when the counter 26 counts the medicines for the predetermined numeral amounts in the high-precision dispensing mode and when the medicine detection sensor 27 does not detect presence of the medicine at a particular region of the second rotator 15, is not necessary to decrease the send-in-turn speed.

The above particular region is the region at the downstream side of the rotational direction when sending the medicine in turn (medicine movement direction when sending in turn) from the detection region of objects for the medicine detection sensor 27 (the part by the two-dot-chain-line frame in FIG. 9 (a)). In other words, the particular region may be any region near to the medicine falling-down part 20. The particular region, for example, may be the region (the part by the two-dot-chain-line frame in FIG. 9 (a)) including the SD range SD1 and SD2 illustrated in FIG. 9 (a). In addition, the detection region may be included within the particular region.

If the rotator controller part 51 decreases the rotation speed constantly when the predetermined numeral amounts (example: 35 tablets) has counted, there is the possibility that time is required before the next medicine is sent out to the medicine falling-down part 20. As the result, there is the possibility that time is required for dispensing 36th tablet and later.

As described above, if the presence of the medicine at the particular region is not detected, by not lowering the rotation speed, the sending-in-turn at a first speed may be kept until the next medicine is moved to the particular region. Thus, the medicine can be dispensed efficiently.

When the rotator controller part 51, after finishing counting of 35th tablet, can not detect the medicine at the particular region, the rotation speed decreased once to a second speed is returned to the first speed. But not limited thereto, the rotation speed may be kept decreased for the 35th tablet and later.

Now, the rotator controller part 51, for example, when the control of the first rotator 14 is synchronized to the control of the rotation speed of the second rotator 15, the rotation speed of the first rotator 14 together with the second rotator 15 may be controlled by switching the above two modes. In this case, it is considered that the rotation speeds of the first rotator 14 and the second rotator 15 are controlled.

<Dispensing Path-Recovering Path>

As shown in FIGS. 4 (a) and (b), the dispensing path 21 is the path for passing (falling-down) the medicine so as to dispense the medicine fallen-down from the second rotator 15 to the medicine container 6 set at the first region 11. The dispensing path 21 includes the dispensing end 21A for dispensing the medicine (medicine as a dispensing object) to the first region 11. The recovering path 22 is the path for passing (falling-down) so as to make the medicines fallen-down from the second rotator 15 recover in the recovering container 7 set at the second region 12. The medicines to be objects for recovering are remaining medicines not dispensed to the medicine container 6. The recovering path 22 includes the recovering end 22A for discharging the medicine to the second region 12. The dispensing path 21 and the recovering path 22 are formed by engaging a front cover C1 and a rear cover C2 each of which is detachable.

In addition, the dispensing end 21A is disposed at a higher position than the recovering end 22A. In other words, shapes, sizes and arranging positions of the dispensing path 21 and the recovering path 22 are defined so as to position the dispensing end 22A at the higher position than the recovering end 22A.

That is, the position of the dispensing end 21A is defined so as to set the medicine container 6 having various seizes. Thus, the medicine container 6 having various sizes can be placed at the first region 11 so as not to make the medicines dispensed fall. Furthermore, the recovering end 22A is defined so as to enable to set the recovering container 7 having a constant height. That is, the height of the second region 12 may be set corresponding to the height of the recovering container 7. Thus, the recovering container 7 is also positioned at the second region so as not make the medicines fall.

As show by an arrow in FIG. 4(a), the medicines sent from the second rotator 15 fall down to the dispensing path 21 or the recovering path 22 through the medicine falling-down part 20. Here, an imaginary reference line BL1, which passes a fall-down point where the medicines sent from the second rotator 15 fall (example: a position to start falling-down to the medicine falling-down part 20) and extends to ±Z axis direction, is defined. The shapes, sizes, and the arranging positions are defined such that the distance D1 between the reference line BL1 and the dispensing end 21A (example: an approximate center of the dispensing end 21A) becomes shorter than the distance D2 between the reference line BL1 and the recovering end 22A (example: approximate center of the recovering end 22A). The distances D1 and D2 may be referred to horizontal distances.

In order to set the distance D1<the distance D2, an elongation direction of the dispensing path 21 can make near to the vertical direction when compared to an elongation direction of the recovering path 22. In this case, since the medicines fallen down from the above falling point becomes hard to impact with an inner wall of the dispensing path 21, the possibility of adhesion of the medicines to the dispensing path 21 due to static electricity and the like generated due to the impact may be decreased. Thus, counting errors due to the adhesion becomes hard to occur and the possibility for dispensing the same number with the counted number to the medicine container 6 becomes high.

In this embodiment, as shown in FIG. 4(a), the arranging positions of the dispensing path 21 and the recovering path 22 (the position of the medicine falling-down part 20 with respect to the second rotator 15) are defined such that the reference line BL1 passes inside of the medicine falling-down part 20. Furthermore, the length of the recovering path 22 is longer than the length of the dispensing path 21 and extends to a lower side of the second rotator 15 and the width regulator 18. That is, in the present embodiment, by setting the length of the dispensing path 21 relatively short (example: shorter than recovering path 22), the relation between the distances D1 and D2 is realized so that the possibility of the adhesion of the medicine to the dispensing path 21 may be lowered.

In addition, according to the embodiment, as shown in FIG. 4 and FIG. 8, the recovering path 22 is positioned to become a lower side of one part of the second rotator 15 (one part of the above medicine moving region), one part of the width regulator 18, and a width regulator moving mechanism 18A (regulator moving mechanism) (described later) for making the width regulator 18 moves toward the ±Y axis direction. In addition, the recovering path 22 is positioned, when viewed from the +Z axis direction, so as to overlap to one part of the second rotator 15, one part of the width regulator 18 and one part of the width regulator moving mechanism. By positioning as described above, the medicine dispensing apparatus 1 may be miniaturized when compared with the configuration that the recovering path 22 is disposed in the position where the recovering path 22 is not overlap to one part of the second rotator 15, one part of the width regulator 18, and one part of the width regulator moving mechanism 18A.

Now, at least one part of the recovering path 22 may be positioned such that the recovering path 22 overlaps with at least one part of the second rotator 15, at least one part of the width regulator 18, or at least one part of the width regulator moving mechanism 18A.

Furthermore, depending on a positional relation ship between the dispensing path 21 and the recovering path 22, the recovering path 22 may be positioned so as not to overlap with one part of the second rotator 15, one part of the width regulator 18 and one part of the width regulator moving mechanism 18A. In this case, one part of the dispensing path 21 may be positioned so as to overlap with one part of the second rotator 15, one part of the width regulator 18 and one part of the width regulator moving mechanism 18A when viewed from the +Z direction. In addition, at least one part of the dispensing path 21 and at least one part of the recovering path 22 may be positioned so as to overlap with one part of the second rotator 15, one part of the width regulator 18 and one part of the width regulator moving mechanism 18A when viewed from the +Z direction.

As described above, at least one part of the dispensing path 21 and/or the recovering path 22 is positioned to overlap with each of the above members, thereby making it possible to miniaturize the medicine dispensing apparatus 1.

<Supporting Member>

As shown in FIG. 4 (a), at the above and proximity of the first region 11, a supporting member 23 for supporting a lateral side of the medicine container 6 is disposed such that the medicine container 6 is placed at the position for reserving the medicines discharged from the discharging end 21A.

The supporting member 23 is configured, in this embodiment, by a gripping mechanism for gripping the medicine container 6 by gripping the lateral sides of the medicine container 6. The gripping mechanism includes two arms movable to the ±X axis direction, and grips the medicine container 6 by two arm parts with moving the two art parts accommodatingly to the shape and the size of the medicine container 6.

As described above, the supporting member 23 is configured in the first region 11, such that the medicine container 6 having various shapes and sizes is faced opposite to the dispensing end 21A while making it possible to support the medicine container 6 in a floating condition.

Besides, the supporting member 23 includes a medicine container detection sensor for detecting the medicine container 6 (not shown). The medicine container detection sensor transmits detection results of the medicine container 6 to a controller 50.

Now, medicine containers 6 having various sizes may only merely set to the first region 11 and for example, a mounting stage movable to the ±Z axis direction with accommodating to the size of the medicine container 6 may be disposed. Furthermore, the medicine detection sensor may be disposed to a casing of the medicine dispensing apparatus 1 at the first region 11.

<Recover Container Sensor>

As shown in FIG. 4(a), to the medicine dispensing apparatus 1, a recover container detection sensor 24 is disposed for detecting the recover container 7 mounted on the second region 12. The recover container detection sensor 24 transmits detection results of the recover container 7 to the controller 50.

<Switching Mechanism>

The medicine dispensing apparatus 1 includes a switching mechanism 25 for switching passage paths of the medicines sent from the second rotator 15 and fallen-down through the medicine-falling-down part 20 between the dispensing path 21 and the recovering path 22. Movements of the switching mechanism 25 is controlled by a switching mechanism controller part 53 (refer to FIG. 10).

The switching mechanism 25 includes a switching valve 25A, a rotation shaft 25B, and a driving shaft 25C. The switching valve 25A is a valve for closing one of the dispensing path 21 or the recovering path 22. FIG. 4(b) illustrates an example where the switching valve 25A closes the recovering path 22. In this case, the dispensing path 21 can be a passage path of the medicines so that the medicines may be dispensed to the dispensing path 21.

The rotation shaft 25B is an axis for making the switching valve 25A rotate. The rotation shaft 25B is supported rotatably by the casing of the medicine dispensing apparatus 1 (example: front cover C1). The rotation shaft 25B can be connected with the driving shaft 25C.

The driving shaft 25C is supported rotatably by the casing of the medicine dispensing apparatus 1. The driving shaft 25C is driven (made driven) by a driving part (example: motor) (not shown). For one example, the switching mechanism controller part 53 may rotate the driving shaft 25C to a predetermined direction (example: clockwise or counter clockwise) with actuating the driving part.

Thereby, the rotation shaft 25B connected with the driving shaft 25C can be made to rotated to the same direction with the driving shaft 25C so that the switching valve 25A may be positioned at a predetermined side (the side for closing the dispensing path 21 or the side for closing the recovering path 22).

The switching mechanism 25 is mounted inside the front cover C1 and the rear cover C2 so as to make it possible to perform the switching of the passage paths of the medicines on the way for falling-down of the medicines sent from the second rotator 15.

Now, the switching mechanism 25 may also switch the passage path of the medicines from the dispensing path 21 to the recovering path 22. Th this case, the switching valve 25A closes the dispensing path 21 to male the recovering path 22 as the passage path of the medicines so as to send the medicines to the recovering path 22.

Furthermore, at least the front cover C1 and the rear cover C2 are engaged together to form a falling-down path defining member for defining the dispensing path 21 and the recovering path 22. In other words, the falling-down path defining member includes at least the front cover C1 and the rear cover C2. As described above, the switching mechanism 25 is disposed to the falling-down path defining member.

As shown In FIGS. 5(a) and (b), the falling-down path defining member is configured so as to be detachably to the medicine dispensing apparatus 1. The switching valve 25A and the rotation shaft 25B are also detachable to the medicine dispensing apparatus 1 as the falling-down path defining member. Now, any known engagement structure may be used for the configuration that makes the falling-down path defining member be detachable to the medicine dispensing apparatus 1.

As one example, a processing flow for the case when cleaning the falling-down path definition member is as the following sequence (1)-(4).

(1): removing the falling-down path definition member (including the switching valve 25A and the rotation shaft 25B) from the medicine dispensing apparatus 1:
(2): decomposing the falling-down definition member to each part (example: front cover C1 and the rear cover C2) to perform cleaning each part after the decomposition:
(3): assembling the falling-down path definition member by composing each part after the cleaning: and
(4): mounting the falling-down path definition member to the medicine dispensing apparatus 1.

As described above, according to the falling-down path definition member being detachable to the medicine dispensing apparatus 1, the falling-down path defining member may be removed from the medicine dispensing apparatus 1 and the falling-down path definition member may be cleaned. Therefore, the medicine dispensing apparatus 1 (more particularly, the falling-down path defining member) may be improved in its maintenability.

As shown in FIG. 5(b), to the driving shaft 25C, a magnet M1 is disposed. Furthermore, as shown in FIG. 5(c), to the rotation shaft 25B, a magnet M2 is disposed. In FIGS. 5(b) and (c), the case where the magnet M1 and the magnet M2 are each disposed two pieces. However, each number of the magnets M1 and magnets M2 is not limited to two pieces. each number of the magnets M1/M2 may be one piece, or may be three pieces ore more.

Each number of the magnets M1/M2 may adequately be set by a designer of the medicine dispensing apparatus 1. So far as the magnet M1/M2 are made to function as a guiding member for making the directions of the rotation shaft 25B and the driving shaft 25C to be accord, the number and arrangements may be optional.

In order to rotate the rotation shaft 25B by the driving shaft 25C, the rotation shaft 25B may be necessarily and adequately connected with the driving shaft 25C. Particularly, the rotation shaft 25B and the driving shaft 25C are necessarily to be connected such that the direction of the rotation shaft 25B and the direction of the driving shaft 25C are in accord.

Therefore, when the magnets M1. M2 were not disposed, a user who has removed and cleaned the falling-down path definition member had to pay attention so as to make the directions of the rotation shaft 25B and the driving shaft 25C in accord. Particularly, the user had to adjust the direction of the falling-down path definition member so as to make the directions of the rotation shaft 25B and the driving shaft 25C accord and to mount the falling-down path definition member to the medicine dispensing apparatus 1.

However, in the case where the magnets M1/M2 are disposed, the magnets M1/M2 function as the guiding members for making the directions of the rotation shaft 25B and the driving shaft 25C in accord. As for one example, the case, where the user tries to mount the falling-down path definition member to the medicine dispensing apparatus 1 without making the directions of the rotation shaft 25B and the driving shaft 25C in accord, is assumed. In this case, by making the rotation shaft 25B become near to the driving shaft 25C, with magnetic attraction force generated between the magnets M1/M2, the rotation shaft 25B can be aligned to the direction of the driving shaft 25C.

Therefore, the user, without being made to adjust the falling-down path defining member such that the directions of the rotation shaft 25B and the driving shaft 25C are in accord, can be made the falling-down path definition member to mount on the medicine dispensing apparatus 1. Thus, in the case where the falling-down path definition member is mounted on the medicine dispensing apparatus 1, utility for user operation can be improved.

After mounting the falling-down path definition member on the medicine dispensing apparatus 1, the rotation shaft 25B and the driving shaft 25C are securely connected by the magnetic attraction force between the magnets M1/M2. Thus, as described above, by rotating the rotation shaft 25B synchronously to the rotation of the driving shaft 25C, the switching of the passage path of the medicines by the switching valve 25A may be performed.

<Counter>

As shown in FIG. 6, the counter 26 of disposed for counting the medicines sent from the second rotator 15. Count control by the counter 26 is controlled by a counter controller part 54.

The counter 26 is positioned such that a detection region of objects (the part surrounded by the two-dots chain line shown in FIG. 6) is formed on the passage path of the medicines sent from the second rotator 15. The counter 26 of the embodiment is configured with a light emitter part 26A and a light receiver part 26B for receiving the light from the light emitting part 26A. The light emitter part 26A is disposed to the casing to which the width regulator movement mechanism 18A is disposed. The light receiver part 26B is disposed at the position opposite to the light emitting part 26A. In other words, the counter 26 is, by receiving (or not receiving) the light emitted from the light emitter part 26A with the light receiver part 26B positioned opposite to the light emitter part 26A to presence or absence of the objects within the detection region, a sensor so-called as a passive receiver type.

Furthermore, the counter 26 is not necessarily to be the sensor of the passive receiver type. For example, the counter 26 may be a sensor so-called as a reflection type in which the light emitted from the light emitter part is reflected with the objects and the reflected light is received with the receiver part to specify the presence or absence of the objects within the detection region.

The counter 26 is positioned so as to be able to count the medicines on the way of falling-down of the medicines sent from the second rotator 15. According to the embodiment, the counter 26 is positioned such that the detection region is formed above of the medicine falling-down part 20 formed by engaging the front cover C1 and the rear cover C2.

The counter 26 is preferably disposed so as to form the detection region at the position where the medicines sent from the second rotator 15 just start the falling-down (falling-down position).

The counter 26, when it detects change in light intensity from the light emitter part 26 with the light receiver part 26B, determines as the medicine passes (falling-down) through the detection region and sends detection results to the counter controller part 54.

The counter 26, when it detects change in light intensity from the light emitter part 26 with the light receiver part 26B, determines as the medicine passes (falling-down) through the detection region and sends detection results to the counter controller part 54. The counter controller part 54, when received the detection result, determines that the medicine of one piece has passed and counts the medicine. Therefore, the function of the counter 26 for counting the medicines is contemplated to be realized by the light emitter part 26A, the light receiver part 26B and the counter controller part 54.

<Height Regulator/Width Regulator>

As shown in FIG. 7 and FIG. 8, the height regulator 17 and the width regulator 18 are regulators for regulating passage of the medicines sent-in-turn form the first rotator 14 and the second rotator 15 depending on a size of the medicine by defining a passage path width of the medicines and are movable so as to change the passage path width. The height regulator 17 is one that regulates a transfer height W1 shown as the passage path width in FIG. 7(b). The width regulator 18 is one that regulates a transfer width W2 shown as the passage path width in FIG. 8(b). The transfer height W1 is a gap from a lower face of the height regulator 17 to an upper face of the second rotator 15 and the transfer width W2 is a gap from an inner periphery part of the second rotator 15 to a curved face 18S.

The height regulator 17 is disposed, with respect to the moving region MR, in the position downstream along the medicine transferring direction under sending-in-turn and above the second rotator 15. The height regulator 17 extends, as shown in FIG. 7(a) and FIG. 8(a), from an outer periphery to an inner periphery of the second rotator 15 while having a guiding face 17S slanting with a predetermined angle along the medicine transferring direction.

The height regulator 17 moves to the ±Z axis direction so as to define the transfer height W1 at the upper face of the second rotator 15. the height regulator moving mechanism is realized, for example, by a screw member 17A and a driving part (example: motor) (not shown) for making the screw member 17A rotate about an axis along which the screw member 17A extends. The screw member 17A is, as shown in FIG. 7 (a), disposed by engaging with a screw receiver part formed to the height regulator 17. By driving the driving part, the screw member 17A is rotated and the height regulator 17 is moved along the ±Z axis direction so that the transfer height W1 may be adjusted depending on the size of the medicine charged. The driving part (in other words, the height regulator moving mechanism) is controlled by a regulator controller part 52 (refer to FIG. 10).

In FIG. 7(a), the condition of the height regulator 17 is shown where the transfer height W≈mm. This positioning is an initial position of the height regulator 17. In FIG. 7(b), the condition of the height regulator 17 is shown in the case after moved to the position of the height W1 (>0 mm) from the initial position.

The width regulator 18 is, as shown in FIG. 7(a), disposed further downstream from the height regulator 17 along the medicine transferring direction and above the second rotator 15. By moving the width regulator 18 along the ±Y axis direction, the minimum transfer width W2 (≈0 mm) can be formed at one part along the peripheral direction on the curved face 18S. Furthermore, the part downstream along the medicine transferring direction of the curved face 18S in the width regulator 18 and a width regulation wall 19 standing at the position opposite to the part defines an end region (medicine guiding region) on the second rotator 15. The medicine guiding region is a region where the medicines passed through the curved face 18S are guided sent out) to the medicine falling-down part 20.

The width regulator 18 moves, for defining the transfer width W2 on the upper face of the second rotator 15, to the ±Y axis direction. The width regulator moving mechanism 18A includes, for example, as shown in FIG. 6, an engagement part 18Aa and a gear 18Ab disposed bellow the width regulator 18. In addition, the width regulator moving mechanism 18A includes a driving part (example: motor) (not shown) for rotating the gear 18Ab.

The engagement part 18Aa is configured with a casing lateral member disposed at a casing side of the medicine dispensing apparatus 1 and a regulator lateral member disposed at lower face side of the width regulator 18. The casing lateral member and the regulator lateral member are disposed so as to extend to the ±Y axis direction and are engaged slidably. Thereby, the width regulator 18 is able to move to the ±Y axis direction. The gear 18Ab is made to rotate by the driving part and by a member connected with the gear 18Ab (not shown) is realized its movement to the ±Y axis direction. By the movement of the width regulator 18 to the ±Y axis direction, the transfer width W2 can be adjusted according to the size of the medicine charged. The driving part (in other words, the width regulator moving mechanism 18A) is controlled by the regulator controller part 52.

FIG. 8 (a) shows the condition of the width regulator 18 at the transfer width W2≈0 mm. This position is an initial position of the width regulator 18. FIG. 8(b) shows the condition of the width regulator 18 after moved to the position from the initial position providing a certain transfer width W2 (>0 mm).

(Adjustment of Transfer Height and Transfer Width)

In an embodiment, using the counter control by the counter 26, the transfer height W1 and the transfer width W2 are adjusted. In this case, as pre-processing for dispensing the medicines of predetermined amounts to the medicine container 6, processing for adjusting the transfer height W1 and the transfer width W2 is performed.

The height regulator moving mechanism makes the height regulator 17 move to the initial position. The width regulator moving mechanism 18A makes the width regulator 18 to the position where the transfer width W2 becomes maximum. In this condition, the medicines to be objects for dispensation are charged to the medicine dispensing part 13 and when the first rotator 14 and the second rotator 15 rotate, the medicines transfer to the first rotator 14 to the second rotator 15 in the moving region MR; however, the movement toward the downstream side is regulated by the height regulator 17. In other words, the medicines transferred to the second rotator 15 are made to fall to the first rotator 14 by collision to a guide face 17S of the height regulator 17.

As the height regulator moving mechanism makes the height regulator 17 from the initial position gradually to widen the transfer height W1, the medicine is transferred to the downstream side without colliding to the guide face 17S at a certain point of time so as to be counted by the counter 26. At the point when the counter 26 counts the first medicine, the movement of the height regulator 17 is terminated.

The regulator controller part 52 calculates, based on a distance from the guide face 17S to an end of the medicine guiding region (near to the falling-down position), a rotation speed of the second rotator, a moving speed of the height regulator 17 toward the +Z axis direction, and the transfer height W1 when the first medicine is counted, the transfer height at the point when the medicine passes the height regulator 17. The calculated transfer height W1 is determined as the transfer height W1 (the position of the height regulator 17) when the medicines will be dispensed.

Particularly, the regulator controller part 52 calculates the transfer height W1 when dispensing the medicine using the following formula:

[Transfer height W1 at Point of Time When Counted First Medicine]−[Distance from Guide Face 17S to End of Medicine Guiding Region]/[Rotation Speed of Second Rotor 15]×[Moving Speed of Height Regulator 17 Toward+Z Axis Direction]. Now, the regulator controller part 52 can determine a value multiplied (or summed) by a certain constant to the transfer height W1 calculated using the above formula as the transfer height W1 when the medicines are dispensed. The certain constant may be values empirically determined adequately.

When the transfer height is determined, the width regulator transferring mechanism 18A makes the width regulator 18 move to the position corresponding to the transfer height W1 of which initial position has been determined as described above. In this condition, the medicines to be the dispensing objects are charged into the medicine charging part 13 and rotations of the first rotator 14 and the second rotator 15 make the medicines transfer to the second rotator 15 from the first rotator 14 at the moving region MR, however, movement to the downstream side is regulated by the width regulator 18. In other words, the medicines transferred to the second rotator 15 are made to fall to the first rotator 14 by the collision to the curved face 18S of the width regulator 18. The position corresponding to the transfer height W1 means the position spaced radially outwardly of the second rotator 15 from the initial position by the length proportional to the transfer height W1.

As the width regulator moving mechanism 18A makes the width regulator 18 move gradually from the initial position so as to widen the transfer width W2, the medicines at a certain point of time, are transferred to the downstream side while contacting with the curved surface 18S and counted by the counter 26. When the counter 26 counts the first medicine, the movement of the width regulator 18 is stopped.

The regulator controller part 52 calculates, based on a distance of the curved face 18S from the position where the transfer width W2 becomes smallest to an end of the medicine guiding region (near to the falling-down position), a moving speed of the width regulator 18 to the +Y axis direction, and the transfer width W2 at the point of time when the first medicine is counted. The calculated transfer width W2 is determined as the transfer width W2 (the position of the width regulator 18) when the medicines are dispensed.

Particularly, the regulator controller part 52 calculates the transfer width W2 when the medicines are dispensed using the following formula:

[Transfer width W2 at Point of Time When Counted First Medicine]−[Distance of Curved Face 18S from Position where Transfer width W2 Becomes Smallest to End of Medicine Guiding Region]/[Rotation Speed of Second Rotator 15]×[Transferring Speed of Width Regulator 18 to +Y Axis Direction]. Now, the regulator controller part 52 can determine a value multiplied (or summed) by a certain constant to the transfer width W2 calculated using the above formula as the transfer width W2 when the medicines are dispensed. The certain constant may be values empirically determined adequately.

After completion of the adjustment of the transfer height W1 and the transfer width W2 (determination of the positions of the height regulator 17 and the width regulator 18), the medicines charged are all recovered to the recovery container 7. Thereby, the condition allowing dispensing processing of the medicines is set.

As described above, the height regulator moving mechanism functions as the driving mechanism for moving the height regulator 17 so as to expand gradually the transfer height W1 as well as for positioning the height regulator 17 using the transfer height W1 at the point of time when the counting by the counter is started as the reference. In addition, the width regulator moving mechanism 18A functions as the driving mechanism for moving the width regulator 18 so as to expand gradually the transfer width W2 as well as for positioning the width regulator 18 using the transfer width W2 at the point of time when the counting by the counter is started as the reference.

After the transfer height W1 is adjusted, for example, the medicines at the upper side among the medicines moved in the condition overlapped upper and lower (for example, disc-shaped tablets, spherical tablets, or capsules) colloid to the guide face 17S of the height regulator 17. Thereby, the medicines are made to fall on the second rotator 15 and to fall on the first rotator 14 from the inner periphery of the second rotator 15. Thus, the height regulator 17 can move the medicines to the downstream in the unoverlapped condition.

At least one medicine passed through the height regulator 17, while contacting with the curved face 18A of the width regulator 18, is transferred to the inner peripheral side of the second rotator 15. Because the transfer width W2 is adjusted, only medicines contacting to the width regulator 18 can pass to the downstream side from the width regulator 18. For example, when the medicines having disc or spherical shapes are transferred side-by-side in the radial direction, an inner tablet not contacting with the width regulator 18 is pushed by an outer tablet contacting with the width regulator 18 so as to make fall to the first rotator 14 from the inner periphery of the second rotator 15.

Furthermore, in the case that the tablets are not positioned side-by-side in the radial direction, the tablet of which center of gravity is positioned inward from the peripheral part of the second rotator 15 is also made to fall from the second rotator 15 to the first rotator 14.

In addition, the regulator controller part 52 may record the determined transfer height W1 and the transfer width W2 with associating with the medicine ID in a storage device 5. In this instance, the regulator controller part 52 makes obtain the medicine ID indicating the medicine inside a retainer container by making the reader device 2 read barcodes included in a sheet (label) stick on the retainer container for retaining the medicines to be objects for dispensing.

In addition, the regulator controller part 52 may record the determined transfer height W1 and the transfer width W2 with associating with the medicine ID in a storage device 5. In this instance, the regulator controller part 52 makes obtain the medicine ID indicating the medicine inside a retainer container by making the reader device 2 read barcodes included in a sheet (label) stick on the retainer container for retaining the medicines to be objects for dispensing. Thereafter, when the medicines in the retainer container are charged in the medicine charging part 13, the regulator controller part 52 determines the transfer height W1 and stores the determined transfer height W1 in the storage device 5 in association with the above medicine ID. Next, when there is no medicine in the first rotator 14, or there are only few medicines in the first rotator 14, the medicines in the retainer container 14 are charged again. Thereafter, the regulator controller part 52 determines the transfer width W2 and stores the determined transfer width W2 in the storage device 5 in association with the above medicine ID.

As described above, in the case that the determined transfer height W1 and the transfer width W2 are registered in the storage device 5, the regulator controller part 52 read out, as pre-processing for the dispensing processing of the medicines, the transfer height W1 and the transfer width W2 associated with the medicine ID indicating the medicine to be objects for dispensing. Then, the regulator controller part 52, based on the retrieved transfer height W1 and the transfer width W2, makes the height regulator 17 and the width regulator 18 move so as to adjust their positions. As described above, in the case that the determined transfer height W1 and the transfer width W2 are registered in the storage device 5, without performing calculation processing of the transfer height W1 and the transfer width W2 on dispensing processing of the medicine and only by reading out from the storage device 5, the above positions can be adjusted.

Now, the regulator controller part 52 may not perform the above calculation of the transfer height W1 and the transfer width W2 and may determine the transfer height W1 and the transfer width W2 at the point of time when stopped due to counting of the first medicine as the transfer height W1 and the transfer width W2 for dispensing the medicine, respectively.

<Medicine Detection Sensor>

As shown in FIG. 7(a), the medicine dispensing apparatus 1 includes a medicine detection sensor 27 (sensor) for detecting whether or not the medicines are present in a particular region of the second rotator 15. In the embodiment, the medicine detection sensor 27 is disposed at one part of the curved face 18S of the width regulator 18 and, for example, is a sensor of the above described reflective type. A detection range of the medicine detection sensor 27 for objects is, in the embodiment, a framed part by two-dot chain lines shown in FIG. 9(a). The medicine detection sensor 27 detects, by detecting the medicines present in the detection range, which is in other words the medicines on the second rotator 15 passing the front thereof, whether or not the medicines are present in the particular region.

In the embodiment, using the rotation speed of the second rotator 15 and the time elapse when the medicines are detected in the above detection range, the position of the medicine passed through the medicine detection sensor 27 (distance from the medicine detection sensor 27 to the medicine) can be calculated. Thereby, it is detected whether or not the medicine is present at SD range SD1 or SD2 shown in FIG. 9 (a). In the embodiment, the above calculation is performed by the controller part 50 (particularly by the rotator controller part 51). However, the above calculation function may have the medicine detection sensor 27. Besides, the medicine detection sensor 27 may be defined as one that includes the above calculation function of the controller 50.

Now, the above detection range may contain the SD range SD1 and SD2. In this case, the medicine detection sensor 27 directly detects whether or not the medicines are present in the SD range SD1 or SD2.

The medicine detection sensor 27, in the high-precision dispensing mode, when detecting the medicine after counting of the medicines for the predetermined numeral amounts by the counter 26, transmits the detection result to the controller part 50. The rotator controller part 51 lowers depending on the detection result the rotation speed of the second rotator 15.

<Controller Part>

The medicine dispensing apparatus 1 includes, as shown in FIG. 10, a controller part 50 and a storage part 70 in addition to the aforementioned configuration. The controller part 50 generally controls each part of the medicine dispensing apparatus 1. The functions of the controller part 50 may be achieved by execution of a program stored in a storage part 70 by CPU (Central Processing Unit).

The storage part 70 stores various programs to be executed by the controller part 50 and data to be used by the programs. Furthermore, various data to be stored by the storage apparatus 5 may be managed by the storage part 70. In this case, the storage apparatus 5 is not necessarily required to be connected to the medicine dispensing apparatus 1 (the medicine dispensing system 100 is not necessary to comprise the storage apparatus 5).

The controller part 50 mainly comprises a rotator controller part 51, a regulator controller part 52, a switching mechanism controller part 53, a counter controller part 54, a checking part 55, a display controller part 56, and an input obtaining part 57.

The rotator controller part 51 controls a rotation of the first rotator 14 by controlling a first rotation controller mechanism, as well as controls a rotation of the second rotator 15 by controlling a second rotation controller mechanism. The rotator controller part 51, for example, controls rotation directions and rotation speeds of the first rotator 14 and the second rotator 15.

The rotator controller part 51 controls the first rotator 14 and the second rotator 15 independently. The rotator controller part 51, for example, makes second rotator 15 rotate always during dispensing process of the medicine, and makes the first rotator 14 rotate only if the medicine is absent on the second rotator 15. The rotator controller part 51 may also rotate intermittently the first rotator 14. Moreover, rotation speeds of the first rotator 14 and the second rotator 15 during rotation may be different from each other. Control of the first rotator 14 and the second rotator 15 is simply required performed with consideration of an efficient medicine dispensing process, avoidance of wasteful electricity consumption, or lifetime of the first rotator 14, the second rotator 15, the first rotation controller mechanism, and the second rotation controller mechanism, and the like. Incidentally, the first rotator 14 and the second rotator 15 are not necessarily required to control independently, and the rotator controller part 51 may control the first rotator 14 and the second rotator 15 so as to interlock the first rotator 14 and second rotator 15.

At the adjustment process of the transfer height W1 and the transfer width W2, and the beginning of dispensing process of the medicines, rotation speeds of the first rotator 14 and the second rotator 15 are set to first speeds, and rotation directions are set to directions to send in turn the medicines (directions toward the medicine falling-down part 20).

The rotator controller part 51 switches between a high-speed dispensing mode or a high-precision dispensing mode on the basis of user's operation, as well as controls at least a rotation speed of the second rotator 15 in accordance with the high-speed dispensing mode or the high-precision dispensing mode, as mentioned above.

Upon completion of dispensing the medicine to the medicine container 6, the rotator controller part 51 stops rotation of the second rotator 15, as well as stops rotation of the first rotator 14 if the first rotator 14 is rotated. Furthermore, the rotator controller part 51 makes at least the second rotator 15 rotate as the first speed if sending the medicine to the recovery container 7. Once the switching mechanism controller part 53 completes an action of the switching valve 25A that allocates the recovering path 22 to a medicine passage path, the rotator controller part 51 makes at least the second rotator 15 rotate upon.

Moreover, the rotator controller part 51 makes the first rotator 14 and the second rotator 15 rotate in a direction to send in turn the medicine, but not limited thereto, and can also make the first rotator 14 and the second rotator 15 rotate in an opposite direction to the direction to send in turn.

The regulator controller part 52 controls movement of the height regulator 17 in ±Z-axis direction by controlling a height regulator moving mechanism, as well as controls movement of the width regulator 18 in the ±Y-axis direction by controlling the width regulator moving mechanism 18A. As mentioned above, the regulator controller part 52 controls movements of the height regulator 17 and the width regulator 18 when the transfer height W1 and the transfer width W2 are adjusted as a preprocessing for the medicine dispensing process. The regulator controller part 52 also controls movements of the height regulator 17 and the width regulator 18 independently.

The switching mechanism controller part 53 controls action of the switching mechanism 25. Specifically, the switching mechanism controller part 53 controls a driving part that rotates the driving axis 25C, thereby actuating the switching valve 25A to allocate the dispensing path 21 or the recovering path 22 to a medicine passage path. The switching mechanism controller part 53 blocks the recovering path 22 by the switching valve 25A at the beginning of medicine dispensing to allocate the dispensing path 21 to the medicine passage path.

The switching mechanism controller part 53 operates the switching mechanism 25 so as to switch the medicine passage path from the dispensing path 21 to the recovering path 22, once the number of the medicine counted by the counter 26 reaches the predetermined dispensing amount. Specifically, under the condition that the counter controller part 54 completes counting of the dispensing amounts and that the recovery container detection sensor 24 detects the recovery container 7, the switching mechanism controller part 53 blocks the dispensing path 21 by the switching valve 25A to allocate the recovering path 22 to the medicine passage path. After completion of the recovery, the switching mechanism controller part 53 actuates the switching valve 25A and blocks the recovering path 22 again to allocate the dispensing path 21 to the medicine passage path.

The counter controller part 54 counts the medicines every time when the counter 26 detects the medicines. The counter controller part 54 also determines whether the counted number of the medicines is the same number as the dispensing amount or not, in the high-precision dispensing mode.

The checking part 55 checks prescription data received from the reader apparatus 2 or storage medicine data with registered medicine data registered in the storage apparatus 5.

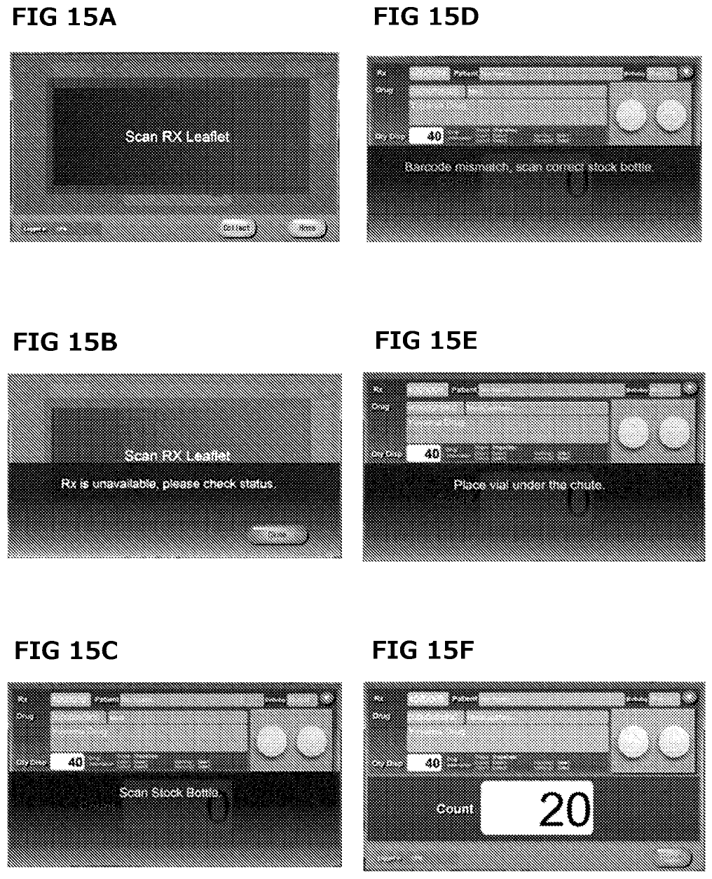

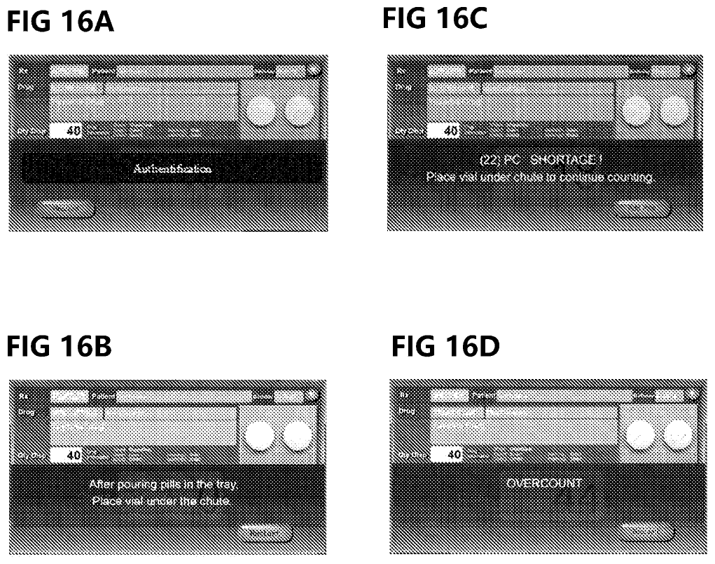

The display controller part 56 make the display part 3A display various display images. FIG. 15 and FIG. 16 show an example of the display images displayed on the display part 3A by the display controller part 56.

The input obtaining part 57 obtains use's operation received by the operation part 3B in the display apparatus 3 from the display apparatus 3. Each of the aforementioned processing of the functional blocks in the controller part 50 is executed on the basis of user's operation obtained by the input obtaining part 57.

[Processing in Medicine Dispensing System]

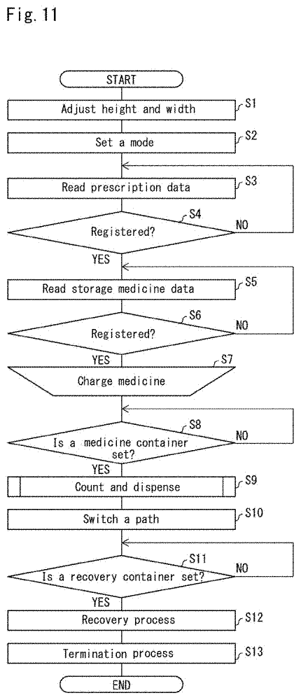

Next, using FIGS. 11-16, an exemplary processing in the medicine dispensing system 100 will be described. FIGS. 11-14 are flowcharts showing an example of various processing flows in the medicine dispensing system 100. FIGS. 15 and 16 are figures showing an example of various display images displayed on the display part 3A. Here, switching valve 25A is assumed to be positioned so as to allocate the dispensing path 21 to the medicine passage path in the initial state.

<General Processing>

Using FIG. 11, a general processing flow in the medicine dispensing system 100 will be described. FIG. 11 is a flowchart showing an example of general processing flows in the medicine dispensing system 100.

The regulator controller part 52 performs positioning of the height regulator 17 (determination of the transfer height W1 at the dispensing process) and positioning of the width regulator 18 (determination of the transfer width W2 at the dispensing process) (Step S1) as a preprocessing for dispensing process of the medicine (processes after Step S2). Briefly, in Step S1, the regulator controller part 52 moves the height regulator 17 and the width regulator 18 to their respective predetermined positions. The regulator controller part 52 starts the process, for example, when medicines (e.g., around 10 tablets) are charged into the medicine charging part 13 and the input obtaining part 57 obtains user's operation to start the medicine dispensing process via the operation part 3B.

Upon completion of the processing, the regulator controller part 52 sends a process completion signal indicating completion of the process to the display controller part 56. The display controller part 56 makes the display part 3A display a selection image for a user to select either of the high-speed dispensing mode and the high-precision dispensing mode. The user touches the selection image, thereby selecting either of the high-speed dispensing mode and the high-precision dispensing mode. The rotator controller part 51 sets either of (or switches between) the high-speed dispensing mode and the high-precision dispensing mode as selected (Step S2).

Upon completion of the selection, the display controller part 56 makes the display part 3A display a display image that prompts reading of the prescription data. For example, displaying a display image shown in FIG. 15 (a) (an initial image in the dispensing process) allows the user to confirm that reading of the prescription data is acceptable. The sentence or the like directly prompting to start the reading may be displayed.

The user holds up a sheet or the like having a printed bar code that indicates the prescription data, over the data reader part 2R in the reader apparatus 2. The reader apparatus 2 obtains the prescription data via the data reader part 2R (Step S3). In the medicine dispensing apparatus 1, the checking part 55 checks the prescription data obtained by the input obtaining part 57 with the registered prescription data registered in the storage apparatus 5, thereby determining whether the prescription data thus obtained is registered in the storage apparatus 5 (Step S4).

If a determination is made by the checking part 55 that the prescription data thus obtained is not registered (failure in checking) (Step S4, NO), the process returns to Step S3. The display controller part 56 accepts this determination result and makes the display part 3A display a display image prompting rereading of the prescription data. For example, a display image shown in FIG. 15 (b) is displayed.

If a determination is made by the checking part 55 that the prescription data thus obtained is registered (success in checking) (Step S4, YES), the display controller part 56 accepts this determination result and makes the display part 3A display a display image prompting reading of the storage medicine data. For example, a display image shown in FIG. 15 (c) is displayed.

The user holds up a sheet or the like which has a printed bar code indicating the storage medicine data and is attached to a storage container, over the data reader part 2R in the reader apparatus 2. The reader apparatus 1 obtains the storage medicine data via the data reader part 2R (Step S5). In the medicine dispensing apparatus 1, the input obtaining part 57 obtains the storage medicine data from the reader apparatus 2 and send it to the checking part 55. The checking part 55 checks the storage medicine data obtained by the input obtaining part 57 with a medicine type ID stored in the storage apparatus 5 with a connection to the prescription data determined as being registered in Step S4 (registered prescription data). This allows the checking part 55 to determine whether the medicine type ID corresponding to the storage medicine data thus obtained is registered in the storage apparatus 5 or not (Step S6).

If a determination is made by the checking part 55 that the medicine type ID corresponding to the storage medicine data thus obtained is not registered (failure in checking) (Step S6, NO), the process returned to Step S5. The display controller part 56 accepts this determination result and makes the display part 3A display a display image prompting rereading of the storage medicine data. For example, a display image shown in FIG. 15 (d) is displayed.

If a determination is made by the checking part 55 that the prescription data thus obtained is registered (success in checking) (Step S6, YES), the display controller part 56 accepts this determination result and makes the display part 3A display a display image prompting setting of the medicine container 6 to the first region 11. For example, a display image shown in FIG. 15 (e) is displayed.

The user confirms this display, and then charges medicines into the medicine charging part 13 (Step S7). Then, the rotator controller part 51 determines whether a medicine container detection signal indicating the medicine container 6 is detected is received from the medicine container detection sensor in the support member 23, thereby determining whether the medicine container 6 is set in the first region 11 (Step S8). If the medicine container 6 is not set (Step S8, NO), the processing of Step S8 is performed until setting. If the medicine container 6 is set (Step S8, YES), the rotator controller part 51 starts rotary actions of the first rotator 14 and the second rotator 15 by receiving the medicine container detection signal. This allows counting by the counter 26, and dispensing of medicine to the medicine container 6 via the dispensing path 21 (Step S9).

Moreover, although the rotator controller part 51 receives the medicine container detection signal under the condition that the two checks described above are succeeded by the checking part 55, it may also directly receive determination result indicating success in the two checks, from the checking part 55a. In this case, the rotator controller part 51 makes the first rotator 14 and the second rotator 15 rotate upon receiving the determination result and the medicine container detection signal.

Thus, the medicine dispensing process automatically starts if (1) checking of the prescription data is succeeded, (2) checking of the storage medicine data is succeeded, and (3) the medicine container 6 is set. This eliminates user's operation for starting the dispensing process, thus allowing to reduce the number of operations for the operation part 3B (the number of touches on the display part 3A).

The counter controller part 54 sends a counting result of medicines to the display controller part 56 every time when counting the medicine. The display controller part 56 accepts this counting result and makes the display part 3A display a display image indicating the counting result during dispensing of medicine. For example, a display image shown in FIG. 15 (f) is displayed. The example in FIG. 15 (f) shows a display image when 20 tablets are dispensed among 40 tablets of dispensing amount (the counter controller part 54 counts for 20 tablets).

Upon completion of counting of the dispensing amount of medicines, the counter controller part 54 sends a counting completion signal indicating completion of counting of the dispensing amount to the rotator controller part 51 and the switching mechanism controller part 53. The rotator controller part 51, upon receiving the counting completion signal, determines as completion of dispensing, and stops rotation of at least second rotator 15. Meanwhile, the switching mechanism controller part 53, upon receiving the counting completion signal, activates the switching valve 25A so as to switch the medicine passage path from the dispensing path 21 to the recovering path 22 (Step S10). Upon completion of the switching, the switching mechanism controller part 53 sends a switching completion signal indicating completion of the switching to the rotator controller part 51.

After receiving the switching completion signal, the rotator controller part 51 determines whether a recovery container detection signal indicating that the recovery container 7 is detected is received from the recovery container detection sensor 24 or not, thereby determining whether the recovery container 7 is set in the second region 12 (Step S11). If the recovery container 7 is not set (Step S11, NO), the process of Step S11 is performed until setting. If the recovery container 7 is set (Step S11, YES), the rotator controller part 51 receives a recovery container detection signal thereby rotating at least the second rotator 15, and sends the residual medicines to the recovery container 7 (Step S12). After a lapse of specified time (sufficient time to dispense the residual medicines), the rotator controller part 51 stops rotation of the second rotator 15. The rotator controller part 51 also stops rotation of the first rotator 14 if the first rotator 14 rotates.

In this way, when the counted number of medicines reaches dispensing amount, a recovery process of the residual medicines (recovery action for the residual medicine) can be performed if the recovery container 7 is set in the second region 12. This eliminates user's operation for starting the recovery process, and thus allows reduction of the number of operations to the operation part 3B.

The rotator controller part 51, upon stopping rotation of the second rotator 15 (and the first rotator 14), sends a rotation stopping signal indicating stopping to the regulator controller part 52 and the display controller part 56. If the regulator controller part 52 receives the rotation stopping signal and a recovery container removal signal indicating removal of the recovery container 7 from the second region 12, from the recovery container detection sensor 24, it moves positions of the height regulator 17 and the width regulator 18 to the initial position (transfer height W1≈0 mm, transfer width W2≈0 mm) (action for positioning the origins).

In this way, upon removal of the recovery container 7 from the second region 12, the action for positioning the origins is executed. This eliminates user's operation for the action for positioning the origins, and thus reduce the number of operations to the operation part 3B. Moreover, removal of the recovery container 7 from the second region 12 provides determination as completion of the recovery process. This eliminates a detection mechanism for detecting completion of the recovery process and user's operation for completing the recovery process.

The display controller part 56, upon receiving the rotation stopping signal or the recovery container removal signal, makes the display part 3A display a display image that prompts to perform user authentication using the authentication apparatus 4. For example, the display image shown in FIG. 16 (a) is displayed. The user authentication makes a user perform approval of medicine dispensing process. Once the user authentication is performed by the authentication apparatus 4, the results are sent to the medicine dispensing apparatus 1. If the authentication is succeeded, the controller part 50 executes a termination process (Step S13). If the authentication is failed, the display controller part 56 may make the display part 3A display a display image that prompts to perform the user authentication again.

Examples of the termination process described above include (1) displaying an alert message, and (2) displaying a display image that prompts cleaning of the dispensing path 21 and the recovering path 22, by the display controller part 56.

Some medicines may be medicine requiring to be stored in a cold place, or medicines likely to generate powder by the dispensing process. Such information is available, for example, from registered medicine data. If registered medicine data includes such information, the display controller part 56 makes the display part 3A display such information as an alert message. Meanwhile, in the case of a medicine likely to generate powder by the dispensing process, in addition to the alert message, a display image that prompts the cleaning described above is displayed by the display part 3A.

### Modified Examples

In the foregoing descriptions, in Step S1, positions of the height regulator 17 and the width regulator 18 are adjusted. However, if the transfer height W1 and the transfer width W2 determined by the regulator controller part 52 are registered in the storage apparatus 5, the process of Step S1 is not necessary. In this case, the regulator controller part 52, for example, retrieves the transfer height W1 and the transfer width W2 from the storage apparatus 5 after Step S3 or Step S5 (before charge of medicines), and moves the height regulator 17 and the width regulator 18 so as to meet the transfer height W1 and the transfer width W2.

<Processing in the High-Precision Dispensing Mode (Slow-Down Processing)>

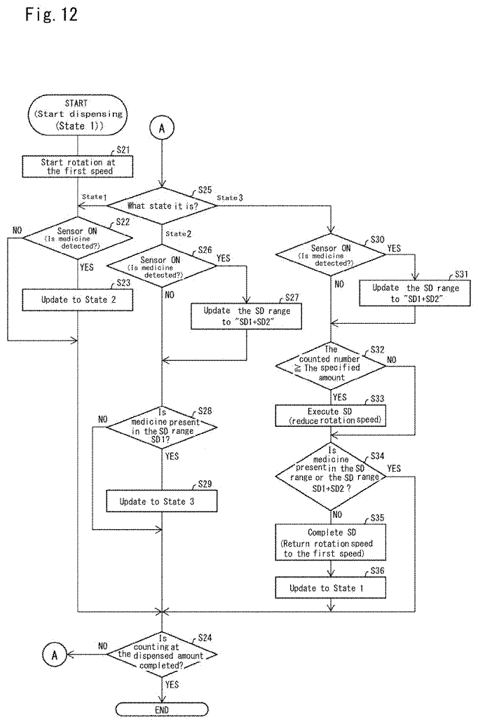

Next, using FIG. 12, a flow of the medicine dispensing process (Step S9 in FIG. 11) in the high-precision dispensing mode will be described. FIG. 12 represents a flowchart showing an exemplary flow of the medicine dispensing process in the high-precision dispensing mode.

When the number of the counted number reaches a specified amount or more, the rotator controller part 51 reduces rotation speed of the second rotator 15 from a first speed to a second speed. A specific example of such process will be described below.

The rotator controller part 51 switches a state of the medicine dispensing apparatus 1 among States 1-3 during dispensing medicines. A state when the rotator controller part 51 starts rotation of the first rotator 14 and the second rotator 15 (a state when the second rotator 15 is rotated at the first speed) is defined as “State 1”. A state when medicine detection sensor 27 detects the medicines is defined as “State 2”. A state when such medicine is present in SD range SD1 or SD2 is defined as “State 3”.

Here, SD range (specific region) is a range set for determining whether the rotation speed is reduced (slow-downed) or not. As shown in FIG. 9 (a), a range at the downstream side adjacent to the medicine detection sensor 27 is SD range SD2. A range extending to the medicine falling-down part 20, at the downstream side adjacent to SD range SD2, is SD range SD1. In “State 1 (the initial state)”, SD range SD1 is set as SD range.

The rotator controller part 51 calculates a position of the medicine passed through the medicine detection sensor 27 (a distance from the medicine detection sensor 27 to such medicine) using rotation speed of the second rotator 15 and a lapse of time from detection of the medicine by the medicine detection sensor 27. The rotator controller part 51 can determine, on the basis of such calculation results, whether the medicine is present in SD range SD1 or SD2. As mentioned above, the medicine detection sensor 27 may have such function.

In Step S9 in FIG. 11, the rotator controller part 51 starts rotation of the first rotator 14 and the second rotator 15 (Step S21). The rotator controller part 51 makes at least second rotator 15 rotate at the first speed (regular speed). The rotator controller part 51 determines whether the medicine detection sensor 27 detects the medicine or not depending on whether a medicine detection signal indicating that the medicine is detected is received from the medicine detection sensor 27 (Step S22). If the rotator controller part 51 determines that the medicine is detected (Step S22, YES), updates “State 1” to “State 2” (Step S23), and proceed to Step S2. If it does not detect the medicine (Step S22, NO), it proceeds to Step S24 with leaving “State 1”.

The counter controller part 54 determines whether the counted number of the medicine reaches the dispensing amount or not (Step S24). The counter controller part 54 sends the determination result to the rotator controller part 51.

If the counted number of the medicines reaches the dispensing amount (Step S24, YES), the dispensing process is ended. In this case, the rotator controller part 51 stops rotation of the second rotator 15 (and the first rotator 14). If the counted number of the medicine do not reach the dispensing amount (if the counted number is less than the dispensing amount) (Step S24, NO), the rotator controller part 51 determines whether it is set to any of “State 1” to “State 3” (Step S25). In the case of “State 1”, reverting to Step S22; in the case of “State 2”, proceeding to Step S26; and in the case of “State 3”, proceeding to Step S30.

With determination as “State 2” in Step S25, the rotator controller part 51 determines, with the medicine detection sensor 27, whether a further medicine is detected or not (Step S26). With determination as a further medicine is not detected (Step S26, NO), the rotator controller part 51 determines whether the medicine detected in Step S22 is present in the SD range SD1 or not (Step S28). With determination as such medicine is present in the SD range SD1 (Step S28, YES), the rotator controller part 51 updates “State 2” to “State 3” (Step S29), and proceeds to Step S24. With determination as such medicine is not present in the SD range SD1 (Step S28, NO), it proceeds to Step S24 with keeping “State 2”.

Meanwhile, with determination as a further medicine is detected (Step S26, YES), the rotator controller part 51 expands the SD range from the SD range SD1 to the SD range SD1+SD2 (Step S27), and proceeds to Step S28.

With determination as “State 3” in Step S25, the rotator controller part 51 determines, as similar to Step S26, whether a further medicine is detected by the medicine detection sensor 27 (Step S30). With determination as a further medicine is not detected (Step S30, NO), the rotator controller part 51 sends such determination result to the counter controller part 54. With determination as a further medicine is detected (Step S30, YES), the rotator controller part 51 expands the SD range from the SD range SD1 to the SD range SD1+SD2 (Step S31), and sends such determination result to the counter controller part 54.

The counter controller part 54, upon receiving the determination result, determines whether the counted number is a specified amount or more or not (Step S32). With determination as the specified amount or more (Step S32, YES), the counter controller part 54 sends such determination result to the rotator controller part 51. The rotator controller part 51, upon receiving such determination result, reduces rotation speed of the second rotator 15 from the first speed to the second speed (Step S33).

If SD range is expanded to SD range SD1+SD2 in Step S27 or S31, the rotator controller part 51 determines whether the medicine is present in the SD range SD1+SD2 or not (Step S34). If the SD range is not expanded to the SD range SD1+SD2 in Step S27 or S31 (if the SD range is the SD range SD1), whether the medicine is present in the SD range SD1 or not is determined (Step S34). Additionally, if the counted number is less than the specified amount in Step S32 (Step S32, NO), the counter controller part 54 proceeds to Step S34 without changing rotation speed.

With determination as is the medicine is present in the SD range SD1 or the SD range SD1+SD2 (Step S34, YES), the rotator controller part 51 proceeds to Step S24 with maintaining the reduced rotation speed (the second speed). With determination as the medicine is not present in the SD range SD1 and the SD range SD1+SD2 (Step S34, NO), the rotator controller part 51 return the rotation speed to the first speed (Step S35), and updates “State 3” to “State 1” (Step S36). Then, it proceeds to Step S24. Additionally, if the counted number is less than the specified amount, the process of Step S33 is not performed, and thus the rotation speed remains at the first speed. Hence, in the case of NO in Step S34, the process of Step S35 is not performed, and Step S36 is proceeded.

For example, provided that the predetermined dispensing amount is 40 tablets while the specified amount less than dispensing amount is 35 tablets, the following consideration may be made for detection of the 36th tablet in Step S22. Once the 36th tablet is detected in Step S22, updating of “State 1”→“State 2” is made (Step S23). Then, if the 37th tablet is not detected in Step S26, whether the 36th tablet is present in the SD range SD1 or not is determined (Step S28), and in the case of the presence in the SD range SD1, updating of “State 2” to “State 3” is made (Step S29). Then, if the 37th tablet is not detected in Step S30, the counted number is the specified amount of 35 tablets or more, and thus the rotation speed is reduced to the second speed (Step S33). If the 36th tablet is present in the SD range SD1 (Step S34, YES), the rotation speed is maintained at the second speed. In contrast, if the 36th tablet is not present in the SD range SD1 (Step S34, NO), it is deemed to be sent to the medicine falling-down part 20, and the rotation speed is returned to the first speed (Step S35).

If the 37th tablet is detected in Step S26 or S30, the SD range is expanded to the SD range SD1+SD2 (Step S27 or S30). This allows the 36th tablet and the 37th tablet to be sequentially detected by the medicine detection sensor 27, and if they are the present in the SD range SD1+SD2, the second speed can be maintained in Step S34. Then, upon determination as the 36th tablet and the 37th tablet are not present in the SD range SD1+SD2 (Step S34, NO), the rotation speed is returned to the first speed. The same applies if the 38th and subsequent tablets are sequentially detected in the medicine detection sensor 27.

Additionally, with determination as the medicine is not present in the SD range SD1+SD2 in Step S34, the rotation speed is returned to the first speed. After the 36th tablet is sent to the medicine falling-down part 20, the second rotator 15 rotates at the first speed until the 37th tablet is detected in the SD range SD1. Thus, higher speed, more efficient dispensing of medicines is provided compared to the case where reduction to the second speed is indiscriminately made if the counted number is the specified amount or more.

<Processing in High-Precision Dispensing Mode (Dispensing Process to Termination Process)>

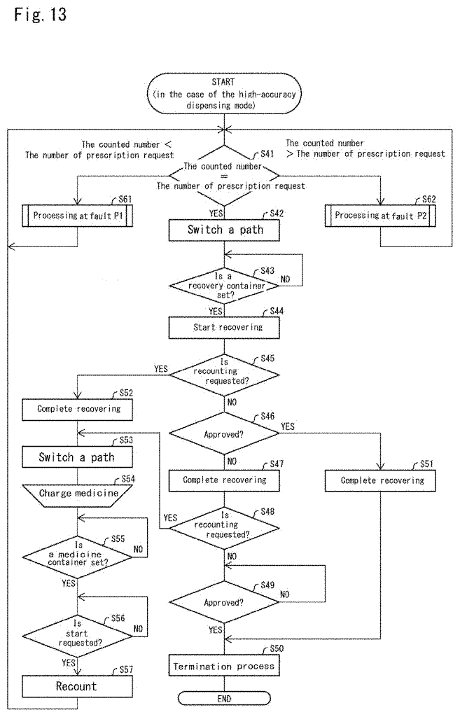

Next, using FIG. 13, a processing flow from a medicine dispensing process to a termination process of the medicine dispensing apparatus 1 in the high-precision dispensing mode will be described. FIG. 13 is a flowchart showing an exemplary flow of processing from the medicine dispensing process to a termination process of a medicine dispensing apparatus 1 in the high-precision dispensing mode.

In the high-precision dispensing mode, the processing of the medicine dispensing apparatus 1 is executed so that medicines with the same number as the dispensing amount (e.g., 40 tablets) may be received in the medicine container 6. In other words, whether the number of the medicine counted by the counter controller part 54 has the same number as the dispensing amount or not is determined, and if only the same number is determined, a recovery process (Step S12 shown in FIG. 11) is performed.

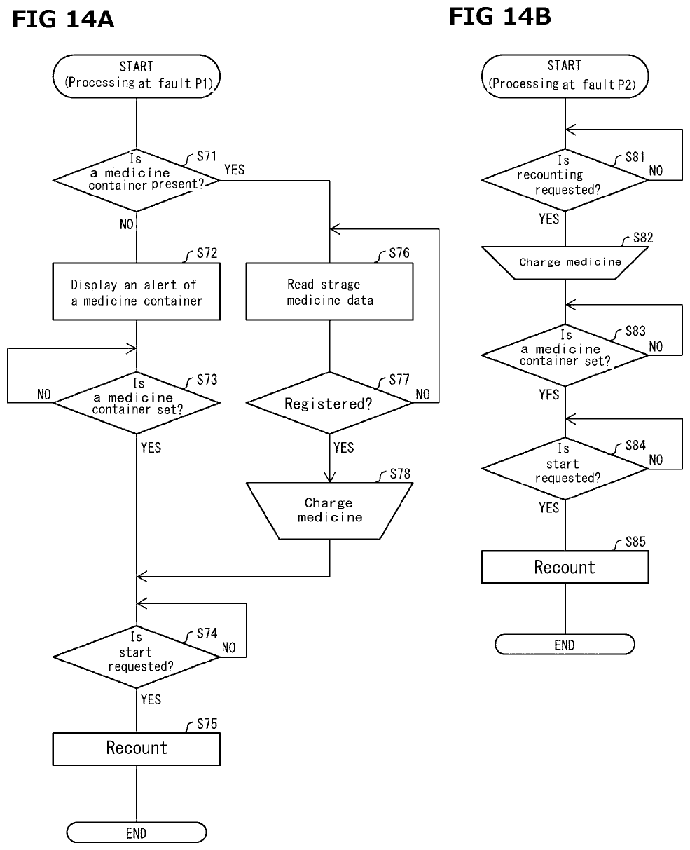

The counter controller part 54 determines whether the counted number of the medicines has the same number as the dispensing amount (Step S41). With determination as the counted number of the medicine is less than the dispensing amount (Step S41, “the counted number<the number of prescription requests”), it proceeds to a processing at fault P1 (Step S61), and returns to Step S41. In the case of the counted number of the medicine above the dispensing amount (Step S41, “the counted number>the number of prescription requests”), it proceeds to a processing at fault P2 (Step S62), and returns to Step S41. The processing at fault P1 and P2 will be described later using FIG. 14.

If the counted number of the medicine has the same number as the dispensing amount (Step S41, “the counted number=the number of prescription requests”), the rotator controller part 51 stops rotation of the second rotator 15 (and the first rotator 14) as similar to Step S10 shown in FIG. 11. Simultaneously, the switching mechanism controller part 53 activates the switching valve 25A so as to switch the medicine passage path from the dispensing path 21 to the recovering path 22 (Step S42).

Then, as similar to Step S11 shown in FIG. 11, whether the recovery container 7 is set in the second region 12 or not is determined by the rotator controller part 51 (Step S43). If the recovery container 7 is not set (Step S43, NO), the processing of Step S43 is performed until setting. If the recovery container 7 is set (Step S43, YES), the rotator controller part 51 rotates the second rotator 15 (and the first rotator 14), and sends residual medicines to the recovery container 7, thereby starting the recovery process (Step S44).

Then, the rotator controller part 51 determines whether the input obtaining part 57 obtains a request for recounting during rotation of the second rotator 15 (and the first rotator 14) (during the recovery process) or not (Step S45). The rotator controller part 51 also determines, during the rotation, whether the input obtaining part 57 receives authentication results showing success in authentication from the authentication apparatus 4 (whether the user approves the medicine dispensing process) or not (Step S46).

In charging the medicines received in the medicine container 6 into the medicine charging part 13 and then executing counting of the medicine again, the user performs via the operation part 3B, a user's operation that represents to execute recounting. In the example in FIG. 16 (a), the user touches “Recount” button, thereby allowing the operation part 3B to obtain such user's operation. The input obtaining part 57 obtains such user's operation as a request for recounting.

If the rotator controller part 51 does not obtain the request for recounting (Step S45, NO) and receives the authentication results described above (Step S46, YES) during the rotation described above, it stops rotation of the second rotator 15 (and the first rotator 14) after a lapse of specified time, thereby completing the recovery process (Step S51). The rotator controller part 51 may determine as completion of the recovery process when the recovery container 7 is removed from the second region 12. At this time, as similar to Step S12 shown in FIG. 11, the height regulator 17 and the width regulator 18 are subjected to an action for positioning the origins. Then, as similar to Step S13, the controller part 50 executes a termination process (Step S50).

If the rotator controller part 51 obtains the request for recounting (Step S45, YES) during the rotation described above, then as similar to Step S51, it completes the recovery process (Step S52) and then sends a rotation stopping signal to the regulator controller part 52. The regulator controller part 52 make the switching valve 25A operate so as to switch the medicine passage path from the recovering path 22 to the dispensing path 21 (Step S53). Then, the switching mechanism controller part 53 sends the switching completion signal to the rotator controller part 51 and the display controller part 56.

After receiving the switching completion signal, the display controller part 56 charges the medicines contained in the medicine container 6 into the medicine charging part 13, as well as makes the display part 3A display a display image that prompts to set again the medicine container 6, which is now vacant, in the first region 11. For example, a display image shown in FIG. 16 (b) is displayed. By checking this display image, the user charges the medicines received in the medicine container 6 into medicine charging part 13, and sets the medicine container 6, which is vacant after charging, in the first region 11 (S54).

After receiving the switching completion signal, the rotator controller part 51 determines whether it receives the medicine container detection signal from the medicine container detection sensor of the support member 23 or not, thereby determining whether the medicine container 6 is set in the first region 11 or not (Step S55). If the rotator controller part 51 determines as the medicine container 6 is set in first region 11 (Step S55, YES), it determines whether the input obtaining part 57 obtains a request for restart or not (Step S56). If the medicine container 6 is not set (Step S55, NO), the processing of Step S55 is performed until setting.

If the medicines received in the medicine container 6 are charged into the medicine charging part 13 and the medicine container 6, which is now vacant, is set into the first region 11, the user performs a user's operation indicating to start recounting via the operation part 3B. In the example in FIG. 16 (b), the user touches “Restart” button, thereby allowing the operation part 3B to obtain such user's operation. The input obtaining part 57 obtains such user's operation as a request for restart.

If the rotator controller part 51 determines as the request for restart is obtained (Step S56, YES), it makes the first rotator 14 and the second rotator 15 rotate, thereby leading to execution of a counting and dispensing processes (Step S9 shown in FIG. 11) (Step S57). If the request for restart cannot be obtained (Step S56, NO), the processing of Step S56 is performed until the request can be obtained.

If the rotator controller part 51 does not obtain the request for recounting during the rotation described above (Step S45, NO) and does not receive the results of authentication described above (Step S46, NO), then as similar to Step S51, it completes the recovery process (Step S47). Then, the rotator controller part 51 executes processing similar as Step S45 and Step S46 (Step S48 and S49). Furthermore, in the case of YES in Step S49, the termination process of Step S50 is executed.

In this manner, the user can input a direction of approval by performing direction of recounting or user authentication without waiting completion of the recovery process. The medicine dispensing apparatus 1 determines presence or absence of the request for recounting during the recovery described above, and can, if the request for recounting is present, perform recounting after completion of the recovery process even without obtaining a user's operation indicating the request for recounting. Moreover, determination is made whether authentication is succeeded during the recovery described above or not, and then if the authentication is succeeded, the termination process can be executed even without confirmation of the authentication after the recovery process. In other words, the processing can be directed to improve efficiency.

<Processing at Fault>

Next, using FIG. 14, a flow of processing at fault of Step S61 and Step S62 shown in FIG. 13 will be described. FIG. 14 represents a flowchart showing an exemplary flow of processing at fault; (a) shows processing in the case that the counted number of the medicine is less than the dispensing amount (the processing at fault P1 of Step S61 shown in FIG. 13), and (b) shows processing in the case that the counted number of the medicine is above the dispensing amount (the processing at fault P2 of Step S62 in FIG. 13).

(Processing at Fault P1)

At first, using FIG. 14 (a), the processing at fault P1 will be described. The controller part 50 determines as the counted number of the medicine is less than the dispensing amount, if (1) the number of charged medicines is less than the dispensing amount, or if (2) the medicine container 6 is removed from the first region 11.

In Step S41 in FIG. 13, the counter controller part 54 determines whether a medicine detection signal indicating that the medicine is detected is not received from the counter 26 for a lapse of specified time during the dispensing process (a state where counting of a dispensing amount of medicines has not been completed yet). If the counter controller part 54 determines as there is no reception for a lapse of a specified time during medicine dispensing, it determines as there is no residual medicine in the first rotator 14 and the second rotator 15. In other words, it determines as the counted number of the medicine is less than the dispensing amount.

Furthermore, in Step S41 in FIG. 13, the counter controller part 54 determines whether the medicine container 6 is removed from the support member 23 or not during the dispensing process (Step S71). If the counter controller part 54 determines as removal during medicine dispensing, it determines as the counted number of the medicine is less than the dispensing amount. If the medicine container 6 is removed, the medicine container detection sensor of the support member 23 sends, for example, a medicine container removal signal indicating removal of the medicine container 6, to the counter controller part 54. The counter controller part 54 determines whether the medicine container removal signal is received from the medicine container detection sensor or not, thereby determining whether the medicine container 6 is removed from the support member 23 or not.

(In Case of Number of Charged Medicines Less than Dispensing Amount)

If the counter controller part 54 does not receive any medicine detection signal from the counter 26 for a predetermined length of time, and if the medicine container 6 is removed from the support member 23 (Step S71, YES), the counter controller part 54 determines as the number of the charged medicines is less than the dispensing amount (in the case of the (1) described above). In this case, the counter controller part 54 sends such determination result to the rotator controller part 51 and the display controller part 56.

The rotator controller part 51, upon receiving such determination result, stops rotation of the second rotator 15 (and the first rotator 14). The display controller part 56, upon receiving such determination result, makes the display part 3A display a display image showing that the counted number is less than the dispensing amount. For example, the display image shown in FIG. 16 (c) is displayed. Furthermore, the sentence or the like directly prompting that the counted number is less than the dispensing amount may be displayed.

The user checks this display image and confirms the absence of medicine on the first rotator 14 and the second rotator 15, and then performs a user's operation to start recounting via the operation part 3B. In the example in FIG. 16 (c), the user touches the “Add pills” button, thereby enabling the operation part 3B (and the input obtaining part 57) to obtain the user's operation.

Once the input obtaining part 57 obtains the user's operation described above, the display controller part 56 makes the display part 3A display a display image that prompts reading of storage medicine data, as similar to Steps S5 and S6 in FIG. 11. The user, upon checking such display image, makes the reader apparatus 2 read storage medicine data. The input obtaining part 57 obtains the storage medicine data from the reader apparatus 2 (Step S76).

The checking part 55 determines whether such storage medicine data is registered in the storage apparatus 5 or not (Step S77). If not registered (Step S77, NO), the process returns to Step S76. If registered (Step S77, YES), the display controller part 56 makes the display part 3A display a display image that prompts to set the medicine container 6 in the first region 11, as similar to Step S7 in FIG. 11. The user, upon checking this display, charges the medicines into the medicine charging part 13 (Step S78).

The rotator controller part 51 determines as similar to Step S56 and S57 in FIG. 13, whether the input obtaining part 57 obtains a request for restart or not (Step S74). If it determines as the request for restart is obtained (Step S74, YES), it makes the first rotator 14 and the second rotator 15 rotate, thereby leading to execution of a counting and dispensing process (Step S9 shown in FIG. 11).

(In Case of Medicine Container Removed from First Region)

Even in receiving the medicine detection signal from the counter 26 during a specified time, if the counter controller part 54 determines as the medicine container 6 is removed from the support member 23 (Step S71, NO), it sends such determination results to the rotator controller part 51 and the display controller part 56.

The rotator controller part 51, upon receiving such determination results, stops rotation of the second rotator 15 (and the first rotator 14). The display controller part 56, upon receiving such determination results, makes the display part 3A display a display image that prompts to set the medicine container 6 in the first region 11 (Step S72). For example, a display image in FIG. 16 (c) is displayed. By checking this display image, the user can insert the medicine container 6 into the support member 23.

The rotator controller part 51 determines, as similar to Step S55 in FIG. 13, whether a medicine container detection signal is received from the medicine container detection sensor of the support member 23 or not, thereby determining whether the medicine container 6 is set in the first region 11 or not (Step S73). If the rotator controller part 51 determines as the medicine container 6 is set in the first region 11 (Step S73, YES), it determines whether the input obtaining part 57 obtains a request for restart or not (Step S74). At this time, the display controller part 56 leads to displaying a display image containing “Restart” button (e.g., a display image in which “Restart” button is contained in the display image in FIG. 15 (e)) so as to allow to obtain the request for restart. Then, in the case of YES in Step S74, the processes after Step S75 mentioned above.

Additionally, if the medicine container 6 is not set (Step S73, NO), the processing of Step S73 is performed until setting. If the request for restart cannot be obtained (Step S74, NO), the processing of Step S74 is performed until the request can be obtained.

(Processing at Fault P2)

Next, using FIG. 14 (b), the processing at fault P2 will be described. If the counter controller part 54 determines as the counted number of the medicine is above the dispensing amount (“the counted number>the number of prescription request” in Step S41 in FIG. 13), it sends the determination results to the rotator controller part 51 and the display controller part 56.

The rotator controller part 51, stops rotation of the second rotator 15 (and the first rotator 14). The display controller part 56, upon receiving the determination results, makes the display part 3A display a display image indicating that the counted number is above the dispensing amount. For example, the display image shown in FIG. 16 (d) is displayed.

The user, upon checking the display image, performs a user's operation indicating that recounting will be executed, via the part 3B. In the example in FIG. 16 (d), the user touch “Recount” button, thereby allowing the operation part 3B to obtain such user's operation. The input obtaining part 57 obtains such user's operation as a request for recounting.

The controller part 50 determines, as similar to Step S45 in FIG. 13, whether the input obtaining part 57 obtains the request for recounting or not (Step S81). Then, if the request for recounting is obtained (Step S81, YES), a processing as similar to the processing Step S54-S57 in FIG. 13 (Step S82-S85) is performed. If the request for recounting cannot be obtained (Step S81, NO), the process of Step S81 is performed until the request is obtained.

### Modified Examples

Next, using Fig. (b), a modified example of the medicine dispensing apparatus 1 will be described. The modified example of the medicine dispensing apparatus 1 includes a counter 260 instead of the counter 26. The counter 260 has not only a function of the counter 26 but also a function of the medicine detection sensor 27. Thus, the example of the medicine dispensing apparatus 1 determines using the counter 260 instead of the medicine detection sensor 27, whether rotation speed is to be reduced or not. In other words, the modified example of the medicine dispensing apparatus 1 may or not include the medicine detection sensor 27.

The counter 260 was substantialized by the so-called reflection sensor mentioned above. The detection range for objects of the counter 260 include the upside of the medicine falling-down part 20 and the end region on the second rotator 15 (medicine guiding region), as shown by a part surrounded with a two-dotted chain line frame in FIG. 9 (b). Such detection range is simply required to be a region close to the medicine falling-down part 20, and further to be a region on the second rotator 15 at the upstream side of the rotation direction in sending in turn the medicines (a region including the end region on the second rotator 15).

In the case of the counted number equal to or more than the specified amount, when the medicine is detected in the detection range, the rotator controller part 51 reduces rotation speed from the first speed to the second speed. In other words, if the counted number is equal to or more than specified amount, the rotator controller part 51 (1) makes the second rotator 15 rotate at the first speed when the medicine is not detected in the detection range, and (2) reduces rotation speed to the second speed and makes the second rotator 15 rotate at the second speed when the medicine is detected in the detection range.

Even in this configuration, if the residual medicines become fewer, efficient dispensing of medicines can be made. Moreover, since the counter 260 has two functions as mentioned above, the medicine dispensing apparatus 1 can be directed to miniaturization.

Incidentally, the counter 260 preferably counts as similar to the counter 26, medicines in falling-down from the second rotator 15 to the medicine falling-down part 20.

[Applicability of Disclosure]

Adjustment of the transfer height W1 and the transfer width W2 in the medicine dispensing apparatus 1 mentioned above is performed with only the counter 26 without any sensor for positioning the height regulator 17 and any sensor positioning the width regulator 18. Such configuration can be applied to an apparatus having the following configurations.

(1) A first rotator for charging medicines.
(2) A second rotator that is disposed outside the first rotator and has a circular shape. Here, medicines charged in the first rotator are translocated to the second rotator, transferred on the second rotator, then fallen down from the second rotator 15, and sent to the outside.
(3) A height regulator and/or width regulator.
(4) A counter for counting medicines falling down from the second rotator.

Examples of apparatuses including the configurations of (1)-(4) include a medicine filling apparatus disclosed in WO2013/18838. This medicine filling apparatus includes a medicine cassette for receiving medicines on the basis of prescription data, and conveyor unit for conveying a vial (corresponding to the medicine container 6) to the medicine cassette. The medicine cassette has the configurations of (1)-(3), and the conveyor unit has the configuration of (4).

Furthermore, examples of apparatuses including the configurations of (1)-(4) include a medicine packaging apparatus disclosed in WO2017/094687. This medicine packaging apparatus includes a first medicine supply part, a manually-distributed medicine supply part, a packaging part, and a second medicine supply part. The first medicine supply part includes a plurality of medicine cassettes and takes a configuration allowing medicines to be dispensed from each of the medicine cassettes. The manually-distributed medicine supply part takes a configuration allowing manually-distributed medicines to be dispensed. The packaging part is for packaging medicines supplied from the medicine cassette or the manually-distributed medicine supply part, with packing paper. The second medicine supply part is, for example, for receiving medicines whose number is required for counting. This second medicine supply part includes the medicine dispensing apparatus having the configurations of (1)-(4).

[Other Configurations]

In the present embodiment, the sending-in-turn mechanism has been described as including the first rotator 14, the second rotator 15, the height regulator 17, and the width regulator 18. However, if charged medicines are sent one-by-one to the medicine container 6 or the recovery container 7, it is not necessarily required to include each of the aforementioned members. For example, the sending-in-turn mechanism may be a single belt-shaped medicine transfer mechanism (e.g., belt). In this case, one end is a part for charging medicines while the other end is a part for sending the medicines to the outside, and a configuration may be made where the passage path width (the height and width of the medicine conveyor mechanism) becomes narrower from the one end to the other end so as to send one-by-one to the outside.

[Implementation with Software]

A control block of the medicine dispensing apparatus 1 (particularly, each block of the controller part 50) may be substantialized by a logical circuit (hardware) formed on an integrated circuit (IC chip) or the like, or may be substantialized by a software.

In the latter case, the medicine dispensing apparatus 1 includes a computer that executes an order from a program which is a software for substantializing each function. This computer includes, for example, one or more processors, as well as includes a computer-readable storage medium that stores the aforementioned program. Then, in the computer, the processor reads and executes the program from the storage medium, thereby achieving a purpose of the present invention. As the processor, for example, CPU (Central Processing Unit) can be used. As the storage medium, in addition to a “non-temporary tangible medium” such as a ROM (Read Only Memory), a tape, a disk, a card, a semiconductor memory, a programmable logical circuit, or the like can be used. Moreover, a RAM (Random Access Memory) or the like that develops the program may be further included. The program may also be supplied via any transmission medium capable of transmitting such program (communication network, broadcast wave, or the like). Incidentally, an aspect of the present invention can be substantialized in form of data signal embedded in carrier wave, in which the program is embodied by electronic transmission.

[Summary]

[1] The medicine dispensing apparatus according to an aspect of the present invention is a medicine dispensing apparatus for sending in turn a plurality of charged medicines, counting and dispensing at least a part of the sent-in-turn medicines, as well as recovering residual medicines; and includes a sending-in-turn mechanism that sends in turn medicines, a counter for counting the medicines sent from the sending-in-turn mechanism, a recovering path having a recovering end that drops and discharges medicines to be recovered, a dispensing path that drops and discharges medicine to be dispensed and has a dispensing end disposed at a position higher than the recovering end, and a switching mechanism that switches a medicine passage path between the dispensing path and the recovering path.

According to the configuration, the height of a first region provided with a medicine container that receives dispensed medicine can be greater than the height of a second region provided with a recovery container that receives medicine to be recovered. This enables various medicine containers having different heights to be disposed into the first region so as not to let the dispensed medicines fall away. Consequently, it is possible to improve convenience of the medicine dispensing apparatus.

Additionally, the height of the recovery container can be determined (can keep the height consistently) beforehand. This enables the height of the second region to be set to fit to the height of the recovery container. Consequently, the recovery container can also be disposed in the second region so as not to let the medicines fall away. Moreover, even if the height of the recovery container is less than the height of the medicine container having the maximum height, the recovery container can be disposed in the second region so as not to let the medicine fall away.

[2] Furthermore, in the medicine dispensing apparatus according to an aspect of the present invention, the switching mechanism switches the passage path from the dispensing path to the recovering path, when the number of medicines that is counted by the counter and is to be dispensed to the dispensing path reaches a predetermined dispensing amount.

According to the configuration, if medicines are charged into the sending-in-turn mechanism in an amount over the dispensing amount, residual medicine not dispensed to the medicine container can be received into the recovery container via the recovering path.

[3] Furthermore, in the medicine dispensing apparatus according to an aspect of the present invention, the horizontal distance to the dispensing end is shorter than the horizontal distance to the recovering end, on the basis of a fall-down position of the medicine send by the sending-in-turn mechanism to fall down thereto.

According to the configuration described above, a fall-down path (dispensing path) to the medicine container draws more similarly to a vertical direction, thus allowing to reduce a risk that the medicine might trend to an unintended direction along the way, thereby providing dispensing more securely.

Moreover, an extending direction of the fall-down path to the medicine container can be made to draw similarly to a vertical direction. In this case, the medicine fell-down from the fall-down position is to be less likely to collide with an inner wall of the dispensing path, and this can decrease possibility that such medicine may adhere to the dispensing path because of static electricity generated from such collision or the like. Consequently, it is possible to suppress occurrence of counting error derived from such adherence, and to increase probability that medicines with the same number as the number of the medicines counted by the counter may be dispensed to the medicine container.

[4] Furthermore, the medicine dispensing apparatus according to an aspect of the present invention may include a support member that supports a lateral side of the medicine container so as to dispose the medicine container at a position to receive the medicine discharged from the dispensing end.

According to the configuration, various medicine containers having different heights can be disposed close to the dispensing end. This can prevent the medicine passed through the dispensing path from dropping away without being received by the medicine container.

[5] Furthermore, in the medicine dispensing apparatus according to an aspect of the present invention, the sending-in-turn mechanism may have a medicine transfer region that extends in a direction different from a fall-down direction of the medicines and transfers the medicines to the fall-down position of the medicines to fall down thereto, and a regulator that defines a passage path width of the medicines so as to, depending on their sizes, so as to regulate passage of the medicines to be sent in turn, as well as is movable so as to change the passage path width; and further include a regulator moving mechanism that moves the regulator; wherein at least one of the recovering path and the dispensing path is placed under at least one part of the medicine transfer region, the regulator, and the regulator moving mechanism; as well as at least one part of at least one of the recovering path and the dispensing path is disposed in an region overlapping with at least one part of the medicine transfer region, the regulator, and the regulator moving mechanism.

According to the configuration described above, the medicine dispensing apparatus can be directed to miniaturization.

[6] Furthermore, in the medicine dispensing apparatus according to an aspect of the present invention, the sending-in-turn mechanism may have a regulator that defines a passage path width of the medicines so as to, depending on their sizes, regulate passage of the medicines to be sent in turn, as well as is movable so as to change the passage path width; and include a driving mechanism that moves the regulator so as to gradually enlarge the passage path width, while positioning the regulator based on a passage path width at the beginning of counting by the counter.

According to the configuration described above, the regulator can be positioned on the basis of the counting by the counter. Accordingly, a sensor for positioning the regulator (a sensor dedicated for a regulator) need not be disposes, and the number of members can thus be reduced.

For example, even if the configuration has, as the regulators, a width regulator that regulates the breadth of an approximate horizontal direction as a passage path width, and a height regulator that regulates the height of an approximate vertical direction, it is not required to dispose a sensor dedicated for the width regulator and a sensor dedicated for the height regulator, respectively.

[7] Furthermore, in the medicine dispensing apparatus according to an aspect of the present invention, the counting by the counter and the switching of the passage path by the switching mechanism may be performed during fall-down of the medicines sent from the sending-in-turn mechanism; and the sending-in-turn mechanism may be capable of switching between a first mode that sends in turn at a constant speed until the predetermined dispensing amounts of medicines are counted, and a second mode that sends in turn with reducing a send-in-turn speed of medicines by counting a specified amount of medicines less than the dispensing amounts.

According to the configuration, in the case of the second mode, a predetermined dispensing amount of medicines can be precisely dispensed to the medicine container. In contrast, in the case of the first mode, more than dispensing amount of medicines might be dispensed to the medicine container, but can be dispensed to the medicine container at a higher speed than that in the case of the second mode.

Being capable of switching a mode between the first mode and the second mode, the medicine dispensing apparatus can improve convenience.

Incidentally, the reduction of a send-in-turn speed of medicines by counting a specified amount of medicines by the counter as mentioned above is not intended to reduce the send-in-turn speed just upon counting the specified amount of medicines by the counter. It is intended to reduce the send-in-turn speed when the specified amount of medicines is counted as well as a specified requirement is satisfied. Examples of the cases of satisfying the specified requirement include a case that, as the following [8], a sensor detects presence of a medicine in a specified region. Examples also include the case that medicine is present in the SD range SD1 or SD2 as mentioned above.

However, it should be noted that if the specified requirement is satisfied just after the counter counts the specified amount of medicines, the send-in-turn speed might be reduced just after such counting.

[8] Furthermore, in the medicine dispensing apparatus according to an aspect of the present invention, the sending-in-turn mechanism may have a first rotator that rotates and thereby moves the charged medicines to an outer peripheral side, and a second rotator that is disposed along the outer periphery of the first rotator and sequentially forwards the medicine moved from the first rotator in circumferential direction; and include a sensor that detects the presence or absence of medicine in a certain region of the second rotator; wherein the sending-in-turn mechanism may not reduce the send-in-turn speed while the sensor does not detect the presence of medicine, even if the counter counts the specified amount of medicines in the second mode.

According to the configuration, in the sending-in-turn mechanism configured with a first and a second rotators, it becomes difficult to sequentially send in turn medicines as the number of the medicines are reduced. Hence, if a medicine is absent in the specific region described above, a line of the medicines is intermittent, and a send-in-turn speed is thus kept not to reduce even in the second mode so as to cause the next medicine to be sent faster. This can allow for efficient dispensing even if the number of the medicines reduced.

[9] Furthermore, the medicine dispensing apparatus according to an aspect of the present invention is a medicine dispensing apparatus for sending-in-turn a plurality of charged medicines, counting and dispensing at least a part of the sent-in-turn medicines, as well as recovering the residual medicines; and includes a send-in-turn mechanism that sends in turn the medicines, wherein the send-in-turn mechanism has a regulator that defines a passage path width of the medicines so as to, depending on their sizes, regulate passage of the medicines to be sent in turn, as well as is movable so as to change the passage path width; a counter that count the medicines forwarded from the send-in-turn mechanism; and a driving mechanism that moves the regulator so as to gradually enlarge the passage path width, while positioning the regulator based on a passage path width at the beginning of counting by the counter.

According to the configuration, a sensor for positioning the regulator need not be disposed, and the number of members can thus be reduced, as similar to the configuration in the [6].

Moreover, according to the configuration, since the regulator is positioned as described above, the passage path width can be regulated so as to pass the medicines one-by-one. This allows medicines passed through a path having such passage path width to fall down one-by-one, and can improve precision of counting by the counter. Consequently, it is possible to improve convenience of the medicine dispensing apparatus.

[10] Furthermore, the medicine dispensing apparatus according to an aspect of the present invention is a medicine dispensing apparatus that sends in turn a plurality of charged medicines, counts and dispenses at least a part of the sent-in-turn medicines, as well as recovers residual medicines; and includes a sending-in-turn mechanism that sends in turn the medicines, a counter that counts the medicines sent from the sending-in-turn mechanism, a recovering path having a recovering end that drops and discharges the medicines to be recovered, a dispensing path having a dispensing end that drops and discharges the medicines to be dispensed, and a switching mechanism that switches the medicine passage path between the dispensing path and the recovering path; wherein the counting by the counter and the switching of the passage path by the switching mechanism is performed while the medicine sent by the sending-in-turn mechanism falls down; wherein the sending-in-turn mechanism can be switched between a first mode that sends in turn at a constant speed until the counter counts a predetermined dispensing amount of medicine, and a second mode that sends in turn with reducing a send-in-turn speed of medicines by counting a specified amount of medicines less than the dispensing amounts.

According to the configuration described above, being capable of switching between the first mode and the second mode similarly as the configuration of the item [7], the medicine dispensing apparatus can improve convenience.

[Supplementary Note]

AS shown in FIG. 17, the medicine dispensing apparatus 1 may comprise a table 12A for supporting the recovery container 7 placed on the second region 12 and a recovery container detection sensor 24A for detecting the recovery container 7 placed on the table 12A.

The table 12A is urged upward by a spring and a recovery end 22A is inserted into the recovery container 7 supported by the table 12 by urging. Thereby, without drawing the recovery end 22A from the recovery container 7 by pushing-down the table 12A, the recovery container 7 can not be taken out from the medicine dispensing apparatus 1 by drawing the recovery container 7 horizontally.

The recovery container sensor 24A is set with a detection range so as not to detect the recovery container 7 even if the recovery container 7 is supported on the table 12A in the condition where the table 12A is push down for drawing the recovery container 7.

In the above configuration, for the purpose of drawing the recovery container 7, pushing down operation of the table 12A and the drawing operation of the recovery container 7 must be required. Since directions of force required in the pushing down operation and the drawing operation are different, some time difference may be present between the operations such that the recovery container 7 can not be removed immediately after the recovery container detection sensor 24A can not detect the recovery container 7. Therefore, according to the above configuration, even if the recovery container 7 is drawn suddenly under the case that the second rotator is rotated, by stopping the second rotator 15 when the recovery container 7 becomes undetected, if the medicine fallen down from the second rotator before stopping the second rotator 15 is made to fallen from the recovery end 22A, the medicine can be recovered by the recovery container 7.

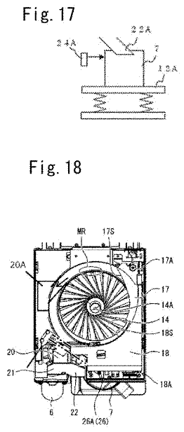

In the configuration described above, though the dispensing path 21 and the recovery path 22 are disposed at the down stream side of the medicine falling-down part 20, as shown in FIG. 18, the recovery path 22 may be disposed at the downstream side of a second medicine falling-down part 20A. By rotating the second rotator 15 reversely, the medicine can be transferred to the second medicine falling-down part 20A.

A rotation speed of the second rotator 15 when the medicine is transferred to a tablet falling-down part 20 may be determined based on a transfer width W2. For example, the speed may be set to the speed proportional to a value multiplied by a coefficient depending on the shape of the medicine to the transfer width W2. The shape of the medicine means a disc shape, a spherical, and a rectangular and so on.

The medicine dispensing apparatus 1 may include a replenishment detection sensor 13A for detecting the replenishment of the medicine in a reservoir space. The medicine dispensing apparatus 1 may stop the dispensing operation when the medicines reserved in the reservoir space are dispensed outside the reservoir space and the replenishment detection sensor 13A detects the replenishment, the medicine dispensing apparatus 1 makes the first rotator 14 or the second rotator stop. As the replenishment detection sensor 13A, a sensor outputting a sign of medicine replenishment when the medicine passes through the medicine discharge part 13 may be used. Such sensors may be placed above the reservoir space and is disposed to a member to which the medicine discharging part 13 is formed in the inside.

S21 of FIG. 12, if the counter 26 does not detect the medicine not less than a predetermined time duration, the transfer width W2 may be widen for a certain length by moving the width regulator 19. By widening the transfer width W2 for a certain length, when the counter 26 detects the medicine, the transfer width W2 registered in the storage device 5 may be changed to the transfer width W2 after widening the transfer width W2 for a certain length. The change of the transfer width W2 registered in the storage device 5 may be performed only when the counter 26 detects the medicine and an interval of the detection of the medicine with the medicine detection sensor 27 is shorter than a certain value.

A sensor for detecting whether or not the medicine is present at the one region on the second rotator may be disposed and when the first rotator 14 may be rotated until time for detecting the medicine by the sensor is not continued for a certain period of time. The certain period of time may be calculated form the rotation speed and the size of the medicine set to be an object for dispensation.

The counter 26, as shown in FIG. 6, may include a plurality of optical sensors of which detection region is linear (constructed by a light emitter part and a light receiver part) instead of the optical sensor of which detection region for objects is a band shape (constructed by the light emitter part 26A and the light receiver part 26B). By aligning a plurality of the optical sensors along the horizontal direction, presence of the medicine may be detected in a range almost similar to the optical sensor constructed by the light emitter part 26A and the light receiver part 26B.

The medicine dispensing apparatus 1 may record for every kind of the medicine whether or not two-dimensional code corresponding to kinds of the medicines is read at least once by the reader device 2. With respect to the medicine of the kind of which two-dimensional code has been read at least once, when the reader device 1 reads one-dimensional code, an instruction for recommending reading of the two-dimensional code may be issued to a user.

The medicine dispensing apparatus 1, upon being input an instruction for dispensing an amount corresponding to a certain ratio to the prescribed amount, may dispense only such amount. For example, to the medicine dispensing apparatus 1, a ½ button and ⅓ button are disposed and when the ½ button is pressed, only ½ of the prescribed amount is dispensed and when the ⅓ button is pressed only 1/of the prescribed amount is dispensed.

A volume may be calculated from a volume and amounts of the medicine to calculate how much vial bottles will be needed so as to provide a recommendation to a user. For example, the volume of the medicine may be obtained form a position of the width regulator 18, a position of the height regulator 19 and the rotation speed of the second rotator 15 when dispensing the medicines. The rotation speed of the second rotator 15 may be set so as to make a period of time for discharging the medicines from the second rotator 15 to be a predetermined one, and thus, the rotation speed of the second rotator becomes high.

When the second rotator 15 is made to rotate and the medicine is not dispensed for longer than a predetermined period of time, the second rotator 2 may be made to rotate reversely and then may be rotate normally. When rotating the second rotator 2 reversely, the first rotator 14 may be made to rotate reversely or normally.

The medicine dispensing apparatus 1 may include a sensor to detect the medicine container 6 set at the first region 11 reaching full-charged with the medicines. When dispensing a predetermined kind of the medicine from the medicine discharging apparatus 1, based on a detection value of the counter 26 when the sensor detects reaching full-charged and volume information of the medicine container 6 set at the first region, the volume of the vial bottles acceptable for charging a predetermined kind of medicine for certain number may be calculated.

Under the operation for recovering the medicines to the recovery container 7 set at the second region 12, when a certain period of time has passed where the medicine is not counted by the counter 26, the position of the height regulator 17 is adjusted to raise the transfer height W1 while adjusting the position of the width regulator 18 to widen the transfer width W2.

The present invention is not limited to each embodiment mentioned above and can be modified in various ways within the scope set forth in the claims, and embodiments derived by appropriately combining each different embodiment with technical means disclosed therein also fall within the technical scope of the present invention.

### REFERENCE SIGNS LIST

1: medicine dispensing apparatus
14: first rotator (sending-in-turn mechanism, medicine transfer region)
15: second rotator (sending-in-turn mechanism, medicine transfer region)
17: height regulator (sending-in-turn mechanism, regulator)
18: width regulator (sending-in-turn mechanism, regulator)
18A: width regulator moving mechanism (regulator moving mechanism, driving mechanism)
26: counter
21: dispensing path
21A: dispensing end
22: recovering path
22A: recovering end
23: support member
25: switching mechanism
27: medicine detection sensor (sensor)
260: counter (sensor)
D1: distance (horizontal distance to the dispensing end)
D2: distance (horizontal distance to the recovering end)

1. A medicine dispensing apparatus for sending a plurality of charged medicines, counting and dispensing at least a part of the sent-in-turn medicines, as well as recovering the residual medicines,
a sending mechanism that sends the medicines,
a counter for counting the medicines sent from the sending mechanism,
a recovering path having a recovering end that drops and discharges a medicine to be recovered,
a dispensing path that drops and discharges a medicine to be dispensed, and has a dispensing end disposed at a position higher than the recovering end,
a switching mechanism that switches medicine passage path between the dispensing path and the recovering path.

2. The medicine dispensing apparatus according to claim 1, wherein the switching mechanism switches the passage path from the dispensing path to the recovering path, when the number of medicines counted by the counter and is to be dispensed to the dispensing path reaches a predetermined dispensing amount.

3. The medicine dispensing apparatus according to claim 1, wherein the horizontal distance to the dispensing end is shorter than the horizontal distance to the recovering end, on the basis of a fall-down position of the medicine send by the sending mechanism to fall down thereto.

4. The medicine dispensing apparatus according to claim 1, comprising a support member that supports a lateral side of the medicine container so as to dispose a medicine container at a position to receive the medicine discharged from the dispensing end.

5. The medicine dispensing apparatus according to claim 1, wherein the sending mechanism comprises:
a medicine transfer region that extends in a direction different from a fall-down direction of the medicines and transfers the medicines to a fall-down position of the medicines to fall down thereto, and
a regulator that defines a passage path width of the medicines, depending on their sizes, so as to regulate passage of the medicines to be sent, as well as is movable so as to change the passage path width;
and further comprises a regulator moving mechanism that moves the regulator,
wherein at least one of the recovering path and the dispensing path is placed under at least one part of the medicine transfer region, the regulator, and the regulator moving mechanism and at least one part of at least one of the recovering path and the dispensing path is disposed in a region overlapping with at least one part of the medicine transfer region, the regulator, and the regulator moving mechanism.

6. The medicine dispensing apparatus according to claim 1, wherein the sending mechanism comprises a regulator that defines a passage path width of the medicines, depending on their sizes, so as to regulate passage of the medicines to be sent, as well as is movable so as to change the passage path width, and
comprises a driving mechanism that moves the regulator so as to gradually enlarge the passage path width, while positioning the regulator based on a passage path width at the beginning of counting by the counter.

7. The medicine dispensing apparatus according to claim 1, wherein the counting by the counter and the switching of the passage path by the switching mechanism are performed during fall-down of the medicines sent from the sending mechanism; and
wherein the sending mechanism can switch between a first mode that sends in turn at a constant speed until the predetermined dispensing amounts of medicines are counted, and a second mode that sends with reducing a sending speed of medicines by counting a specified amount of medicines less than the dispensing amounts.

8. The medicine dispensing apparatus according to claim 7, wherein the sending mechanism has:
a first rotator that rotates and thereby moves the charged medicines to an outer peripheral side, and
a second rotator that is disposed along the outer periphery of the first rotator and sends the medicine moved from the first rotator in circumferential direction;
and comprises:
a sensor that detects the presence or absence of medicine in a certain region of the second rotator,
wherein the sending mechanism does not reduce the send speed while the sensor does not detect the presence of medicine, even if the counter counts the specified amount of medicines in the second mode.
